(19) United States
(12) Patent Application Publication
(10) Pub. No.: US 2012/0301198 A1
(43) Pub. Date: Nov. 29, 2012

(54) IMAGE FORMING SYSTEM, IMAGE FORMING METHOD, AND NON-TRANSITORY COMPUTER READABLE MEDIUM

(75) Inventors: Hiroyuki MOMIYAMA, Kanagawa (JP); Michio TADA, Kanagawa (JP); Takashi ABE, Kanagawa (JP); Yoshiyuki TAKAISHI, Kanagawa (JP); Akira IWASAKA, Kanagawa (JP); Toshitaka TANAKA, Kanagawa (JP)

(73) Assignee: FUJI XEROX CO., LTD., Tokyo (JP)

(21) Appl. No.: 13/304,947

(22) Filed: Nov. 28, 2011

(30) Foreign Application Priority Data
May 25, 2011 (JP) 2011-117331

(51) Int. Cl. G03G 15/00; B65H 9/00

(52) U.S. Cl. 399/361; 271/226

(57) ABSTRACT

An image forming system includes an image forming unit, a feeding unit, a side edge reversal unit, a leading edge reversal unit, and a control unit, wherein, when there is a request for image formation on a bundle of sheets including a special sheet having a special part at an edge so that the edge is not straight and there is a request for image formation on both surfaces of the special sheet, the control unit controls the feeding unit, the image forming unit, the side edge reversal unit, the image forming unit to transport the special sheet having the image of the preceding page formed thereon to the downstream side after the front and back of the sheet are reversed by the leading edge reversal unit.

### CROSS-REFERENCE TO RELATED APPLICATIONS

This application is based on and claims priority under 35 USC 119 from Japanese Patent Application No. 2011-117331 filed May 25, 2011.

### BACKGROUND

(i) Technical Field

The present invention relates to an image forming system, an image forming method, and a non-transitory computer readable medium.

(ii) Related Art

In the related art, an image forming apparatus that performs image formation on both the front and back surfaces of a sheet is known.

### SUMMARY

According to an aspect of the invention, there is provided an image forming system including:

an image forming unit that forms an image on a sheet having a first edge, a second edge located opposite to the first edge, a first side edge intersecting the first edge, and a second side edge located opposite to the first side edge;

a feeding unit that feeds the sheet to the image forming unit from the first edge;

a transporting unit that transport the sheet;

a side edge reversal unit having a carrying-in section that carries in the sheet from the first edge, a reversal section that reverses the front and back of the sheet carried in by the carrying-in section, and a carrying-out section that carries out the sheet from the first edge after the sheet is reversed by the reversal section;

a leading edge reversal unit that reverses the front and back of the sheet transported with the first edge as a leading edge and changes the leading edge from the first edge to the second edge; and

a control unit that controls the operation of the image forming unit, the feeding unit, the transporting unit, the side edge reversal unit, and the leading edge reversal unit,

wherein, when there is a request for image formation on a bundle of sheets including a special sheet having a special part at an edge so that the edge is not straight and

there is a request for image formation on both surfaces of the special sheet,

the control unit controls

the feeding unit to feed the special sheet with the edge having the special part as a trailing edge;

the image forming unit to form an image of a following page on the special sheet;

the side edge reversal unit to reverse the front and back of the special sheet having the image of the following page formed thereon, in a state where the special part is positioned at a trailing edge;

the image forming unit to form an image of a preceding page on the special sheet of which the front and back are reversed by the side edge reversal unit; and

the transporting unit to transport the special sheet having the image of the preceding page formed thereon to the downstream side after the front and back of the sheet are reversed by the leading edge reversal unit.

### BRIEF DESCRIPTION OF THE DRAWINGS

Exemplary embodiments of the present invention will be described in detail based on the following figures, wherein:

FIG. 1 is a view when an image forming apparatus related to an exemplary embodiment is seen from the near side;

FIG. 2 is a perspective view showing the overall configuration of a sheet reversal device related to the exemplary embodiment;

FIG. 3 is a view illustrating the relationship between respective transporting paths provided in the sheet reversal device and transporting directions of a sheet in the respective transporting paths;

FIG. 4 is a perspective view in a case where a second reversal guide plate is further set to an open state in the sheet reversal device shown in FIG. 2;

FIG. 5 is a perspective view in a case where a reversal section is further set to an open state in the sheet reversal device shown in FIG. 2;

FIG. 6 is a perspective view in a case where the second reversal guide plate is further set to an open state in the sheet reversal device shown in FIG. 5;

FIG. 7 is a perspective view in a case where a second carrying-in guide plate is further set to an open state in the sheet reversal device shown in FIG. 6;

FIG. 8 is a perspective view in a case where a second carrying-out guide plate is further set to an open state in the sheet reversal device shown in FIG. 6;

FIG. 9 is a view illustrating the configuration of the respective transporting paths and respective transport parts in the sheet reversal device of the present exemplary embodiment;

FIGS. 10A to 10E are views illustrating the configuration of feed roll pairs provided in the respective transport parts of the sheet reversal device;

FIGS. 11A to 11E are views illustrating the relationship between the respective transporting paths and the respective feed roll pairs in the sheet reversal device of the exemplary embodiment;

FIGS. 12A to 12D are views showing an example of the configuration of an advancing and retreating mechanism that advances and retreats an upstream first reversal roll pair, and a rotating mechanism that rotates the upstream first reversal roll pair;

FIG. 13 is a perspective view showing a first carrying-in guide plate and a carrying-in-side switching plate of a carrying-in section;

FIGS. 14A and 14B are views illustrating a configuration surrounding a butting member;

FIGS. 15A to 15F are views showing the actions of the butting member and a moving mechanism;

FIG. 16 is a view showing the operation when there is a request for image formation on both surfaces of a tabbed sheet;

FIGS. 17A and 17B are views showing an operation when there is a request for image formation on a bundle of sheets including a tabbed sheet and a request for image formation on both surfaces of a sheet;

FIG. 18 is a flowchart showing a procedure when a control unit performs image formation on both surfaces of a tabbed sheet within a bundle of sheets including the tabbed sheet;

FIG. 19 is a flowchart showing a procedure when the control unit performs image formation on both surfaces of a plain sheet within a bundle of sheets including a tabbed sheet;

FIGS. 20A and 20B are views showing another operation when there is a request for image formation on a bundle of sheets including a tabbed sheet and a request for image formation on both surfaces of a sheet;

FIG. 21 is a flowchart showing a procedure when the control unit performs image formation on both surfaces of a plain sheet within a bundle of sheets including a tabbed sheet;

FIG. 22 is a view showing the schematic configuration of a sheet processing system.

### DETAILED DESCRIPTION

An exemplary embodiment will be described below in detail with reference to the accompanying drawings.

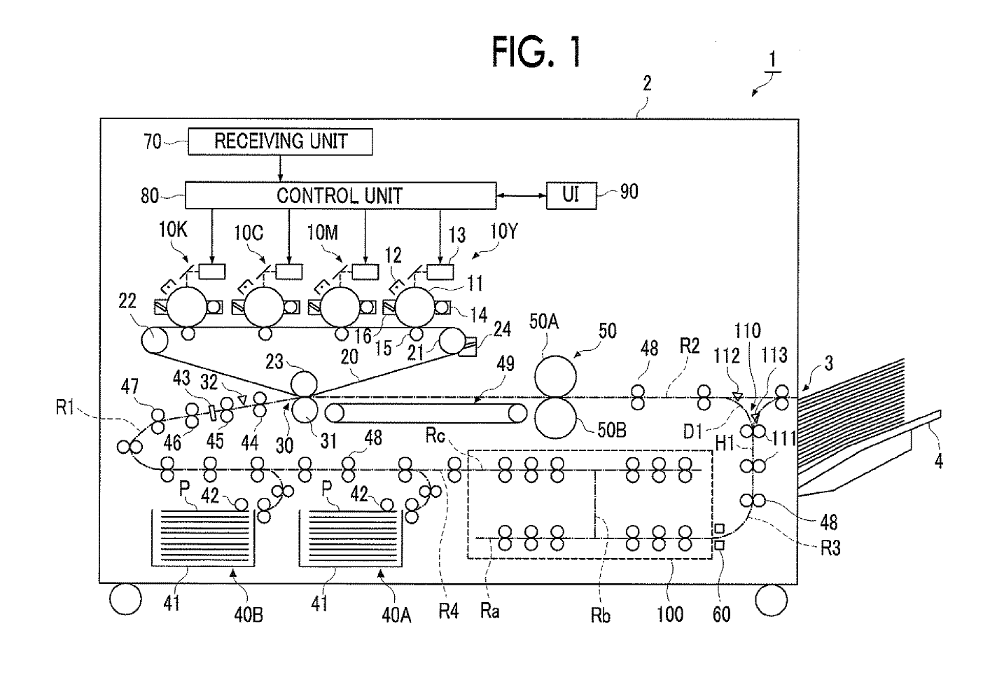

FIG. 1 is a view when an image forming apparatus 1 related to the exemplary embodiment is seen from the near side. The image forming apparatus 1 as an example of an image forming system shown in FIG. 1 has a so-called tandem configuration, and includes plural image forming units 10 (10Y, 10M, 10C, and 10K) that form toner images of respective color components, using an electrophotographic method. Additionally, the image forming apparatus 1 includes a CPU (Central Processing Unit), a ROM (Read Only Memory), a RAM (Random Access Memory), and the like, and includes a control unit 80 as an example of control unit that controls the operation of respective devices and respective sections that constitute the image forming apparatus 1. Moreover, the image forming apparatus 1 has a receiving unit 70 that receives image data or the like, for example, from a personal computer (PC), an image reader (scanner), or the like.

Additionally, the image forming apparatus 1 includes a user interface section (UI) 90 that is constituted by a touch panel or the like and that outputs an instruction received from a user to the control unit 80, and presents a user the information from the control unit 80. A user is allowed to perform a request for image formation on both surfaces of a tabbed sheet to be described below via the personal computer (PC) or the user interface section (UI) 90. Additionally, the user is allowed to perform a request for image formation on a bundle of sheets composed of a tabbed sheet and a plain sheet or image formation on a bundle of sheets composed of only a tabbed sheet. In that case, the user is allowed to instruct which page of a number of pages in the bundle of sheets is an image for the tabbed sheet.

Additionally, the image forming apparatus 1 includes an intermediate transfer belt 20 to which the respective color component toner images formed by the respective image forming units 10 are sequentially transferred (primarily transferred), and that holds these toner images, and a secondary transfer device 30 as an image forming unit that collectively transfers (secondarily transfers) the toner images on the intermediate transfer belt 20 to a sheet P that is formed in the shape of a rectangle.

Each of the image forming units 10 includes a rotatably attached photoreceptor drum 11. Additionally, in each of the image forming units 10, a charging device 12 that charges the photoreceptor drum 11, an exposure device 13 that exposes the photoreceptor drum 11 to write an electrostatic latent image, and a developing device 14 that forms the electrostatic latent image on the photoreceptor drum 11 as a visible image with a toner are provided around the photoreceptor drum 11. Moreover, each of the image forming units 10 is provided with a primary transfer device 15 that transfers each color component toner image formed on the photoreceptor drum 11 to the intermediate transfer belt 20, and a drum cleaning device 16 that removes the residual toner on the photoreceptor drum 11.

Next, the intermediate transfer belt 20 is stretched over three roll members 21 to 23 that are rotatably provided, respectively, and is provided so as to rotate. The roll member 22 among these three roll members 21 to 23 drives the intermediate transfer belt 20. Additionally, the roll member 23 is arranged to face the secondary transfer roll 31 with the intermediate transfer belt 20 therebetween, and the secondary transfer device 30 is constituted by the secondary transfer roll 31 and the roll member 23. In addition, the belt cleaning device 24 that removes the residual toner on the intermediate transfer belt 20 is provided at a position that faces the roll member 21 with the intermediate transfer belt 20 therebetween.

Additionally, the image forming apparatus 1 is provided with a first transporting path R1 through which the sheet P transported toward the secondary transfer device 30 passes, a second transporting path R2 through which the sheet P after passing through the secondary transfer device 30 passes, a third transporting path R3 that branches from the second transporting path R2 on the downstream side of the fixing device 50 to be described below, and extends to below the first transporting path R1, and guides a sheet P to the first reversal device 100 to be described below, and a fourth transporting path R4 that guides the sheet passed through the first reversal device 100 again to the first transporting path R1. Here, in the first transporting path R1 to the fourth transporting path R4, transport of a sheet P is performed such that the two sides (one side and the other surface located opposite to this one side that will be described below in detail) that face each other among four sides of the sheet P move along these transporting paths.

The image forming apparatus 1 of the present exemplary embodiment further includes a first reversal device 100 that reverses the front and back of the sheet P carried in from the third transporting path R3, and carries out the sheet to the fourth transporting path R4. The first reversal device 100 has a function to reverse a sheet P about an axis running along a sheet transporting direction in the first transporting path R1 and a sheet transporting direction in the third transporting path R3. That is, the first reversal device 100 of the present exemplary embodiment reverses the relationship between two lateral edges (side edges) of a sheet P, without changing the relationship between the leading edge end and trailing edge of the sheet P in the sheet transporting direction. The first reversal device 100 functions as an example of side edge reversal unit. The first reversal device 100 has a carrying-in path Ra connected to the third transporting path R3, a carrying-out path Rc connected to the fourth transporting path R4, and a reversal path Rb through which the front and back of the sheet P supplied from the carrying-in path Ra are reversed and supplied to the carrying-out path Rc.

In addition, a sheet detection sensor 60 that detects passage of a sheet P is attached to the third transporting path R3 that becomes the carrying-in side of a sheet P in first reversal device 100.

Additionally, the image forming apparatus 1 of the present exemplary embodiment includes a second sheet reversal device 110 as an example of a leading edge reversal unit that reverses the front and back such that the leading edge and trailing edge of a sheet P, in the sheet transporting direction, which passes through the second transporting path R2, are switched. The second reversal device 110 reverses the relationship between the leading edge end and trailing edge of a sheet P, without changing the relationship between two lateral edges of the sheet P in the sheet transporting direction. The second sheet reversal device 110 will be described below in detail.

Moreover, in the image forming apparatus 1 of the present exemplary embodiment, a housing 2 of the image forming apparatus 1 is formed with an opening portion 3. Additionally, the image forming apparatus 1 includes a sheet stack section 4 on which the sheet P discharged from the opening portion 3 is stacked. The sheet that is not guided to the third transporting path R3 among the sheet P transported along the second transporting path R2 is discharged to the outside of the housing 2 through the opening portion 3, and is stacked on the sheet stack section 4.

Additionally, the image forming apparatus 1 further includes a first sheet supply device 40A that supplies a sheet P to the first transporting path R1, and a second sheet supply device 40B that is provided on the downstream side of the first sheet supply device 40A in the transporting direction of the sheet P, and supplies the sheet P to the first transporting path R1. In addition, the first sheet supply device 40A and the second sheet supply device 40B are similarly configured, and the first sheet supply device 40A and the second sheet supply device 40B are respectively provided with a sheet storing section 41 that stores a sheet P, and a take-out roll 42 that takes out the sheet P stored in the sheet storing section 41 to transport the sheet P. The sheet storing section 41 may store the tabbed sheet to be described below such that the tabbed sheet is taken out by the take-out roll 42 from a side that faces a side formed with a tab. That is, in FIG. 1, the tabbed sheet may be stored in a state where the side formed with a tab becomes the left.

Additionally, a first feed roll 44, as an example of feeding unit that transports (feeds) the sheet P on the first transporting path R1 toward the secondary transfer device 30, is provided on the upstream side of the secondary transfer device 30 on the first transporting path R1. Moreover, a second feed roll 45 that transports a sheet P toward the first feed roll 44, a third feed roll 46 that transports a sheet P toward the second feed roll 45, and a fourth feed roll 47 that transports a sheet P toward the third feed roll 46 are provided. A registration sensor 32 that detects passage of the leading edge of a sheet P is provided on the upstream side of the first feed roll 44 in the sheet transporting direction.

Additionally, in addition to these feed rolls, plural feed rolls 48 that transport the sheet P located on the first transporting path R1, the second transporting path R2, the third transporting path R3, and the fourth transporting path R4 are provided on these transporting paths. In addition, the first feed roll 44, the second feed roll 45, the third feed roll 46, the fourth feed roll 47, and the feed roll 48 are rotatably provided, are constituted by a pair of roll-shaped members that push one another, and perform transport of a sheet P as one roll-shaped member is rotationally driven.

Additionally, in the present exemplary embodiment, butting member 43 against which the leading edge of a sheet P is butted is provided between the second feed roll 45 and the third feed roll 46. In the present exemplary embodiment, the skew (the inclination of a sheet P with respect to the transporting direction) of a sheet P is corrected as the leading edge of a sheet P is butted against the butting member 43. In addition, after the skew of a sheet P is corrected by the butting member 43, the butting member 43 withdraws from the first transporting path R1. The peripheral structure of the butting member 43 will be described below in detail.

Additionally, the image forming apparatus 1 further includes a fixing device 50 that fixes an image secondarily transferred onto a sheet P by the secondary transfer device 30 on this sheet P on the second transporting path R2. The fixing device 50 has a heating roll 50A heated by a built-in heater (not shown) and a pressing roll 50B that presses the heating roll 50A. In the fixing device 50, a sheet P is heated and pressurized and the image on the sheet P is fixed to the sheet P as the sheet P passes between the heating roll 50A and the pressing roll 50B.

Moreover, a belt transport section 49 that transports the sheet P that has passed through the secondary transfer device 30 to the fixing device 50 is provided between the secondary transfer device 30 and the fixing device 50. Here, the belt transport section 49 has a belt that moves circularly, and places a sheet P on this belt to perform transport of the sheet P.

Additionally, in the image forming apparatus 1 of the present exemplary embodiment, not only an image may be formed on one surface of the sheet P supplied from the first sheet supply device 40 or the like, but an image may be formed on the other surface of the sheet P. More specifically, in the image forming apparatus 1, the front and back of the sheet P that has passed through the fixing device 50 are reversed by the first reversal mechanism 100, and the sheet P whose front and back are reversed is transported again to the secondary transfer device 30. Then, an image is transferred to the other surface of the sheet P by the secondary transfer device 30. Then, this sheet P passes through the fixing device 50 again, and this transferred image is fixed on the sheet P. This forms images on both surfaces of the sheet P.

Next, the first reversal device 100 will be described in detail.

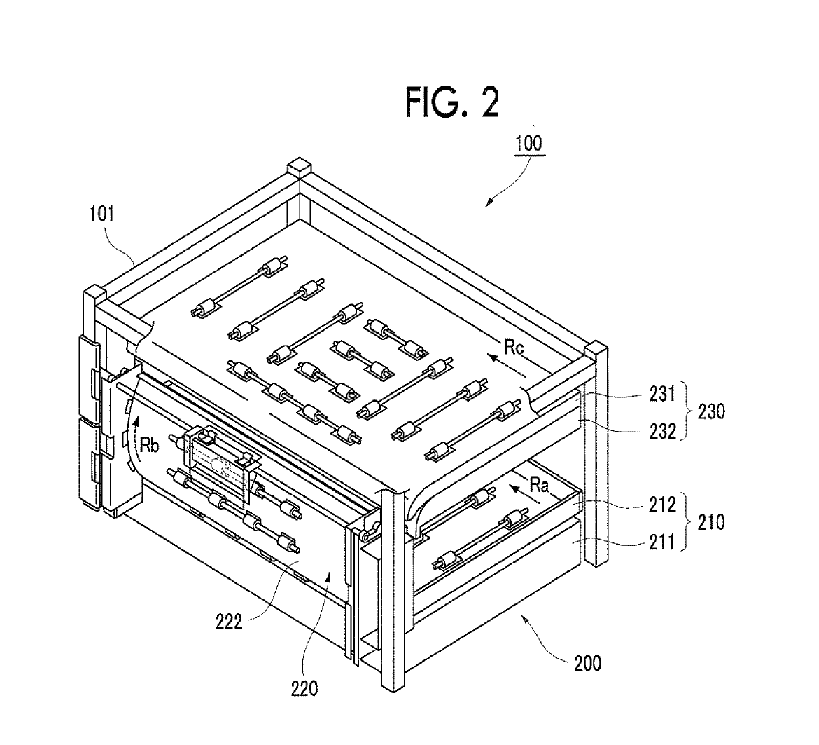

FIG. 2 is a perspective view showing the overall configuration of the first reversal device 100 related to the present exemplary embodiment.

The first reversal device 100 includes a frame body 101 including four struts and stays that connect the respective struts, and a sheet guide unit 200 that is attached to the frame body 101 and used for the reversal transport of a sheet P.

The sheet guide unit 200 of them includes a carrying-in section 210 to which a sheet P is carried in from the third transporting path R3, a reversal section 220 that reverses the front and back of the sheet P fed in from the carrying-in section 210, and a carrying-out section 230 that carries out the sheet P fed in from the reversal section 220 to the fourth transporting path R4. Here, in the present exemplary embodiment, the carrying-out section 230 is arranged above the carrying-in section 210, and as seen from above, the carrying-out section 230 and the carrying-in section 210 overlap each other. In contrast, the reversal section 220 is arranged at a position that becomes the near side in FIG. 2, that is, the near side in the image forming apparatus 1 shown in FIG. 1, with respect to the carrying-in section 210 and the carrying-out section 230. Thereby, in the first reversal device 100, a space is formed between the carrying-in section 210 and the carrying-out section 230 that constitute the sheet guide unit 200.

Additionally, the carrying-in section 210 is provided with the carrying-in path Ra that receives a sheet 9 from the third transporting path R3, the reversal section 220 is provided with the reversal path Rb for receiving the sheet P from the carrying-in path Ra and reversing the sheet P, and the carrying-out section 230 is provided with the carrying-out path Rc for receiving the sheet P from the reversal path Rb and transferring the received a sheet P to the fourth transporting path R4. Accordingly, in the sheet guide unit 200, the carrying-in path Ra, the reversal path Rb, and the carrying-out path Rc constitute a mutually continuous transporting path.

Here, the carrying-in section 210 includes a first carrying-in guide plate 211 and a second carrying-in guide plate 212 that are arranged to face each other so as to form the carrying-in path Ra. In this example, the first carrying-in guide plate 211 is located outside (below) the first reversal device 100 as seen from the second carrying-in guide plate 212, and the above-described space is formed above the second carrying-in guide plate 212.

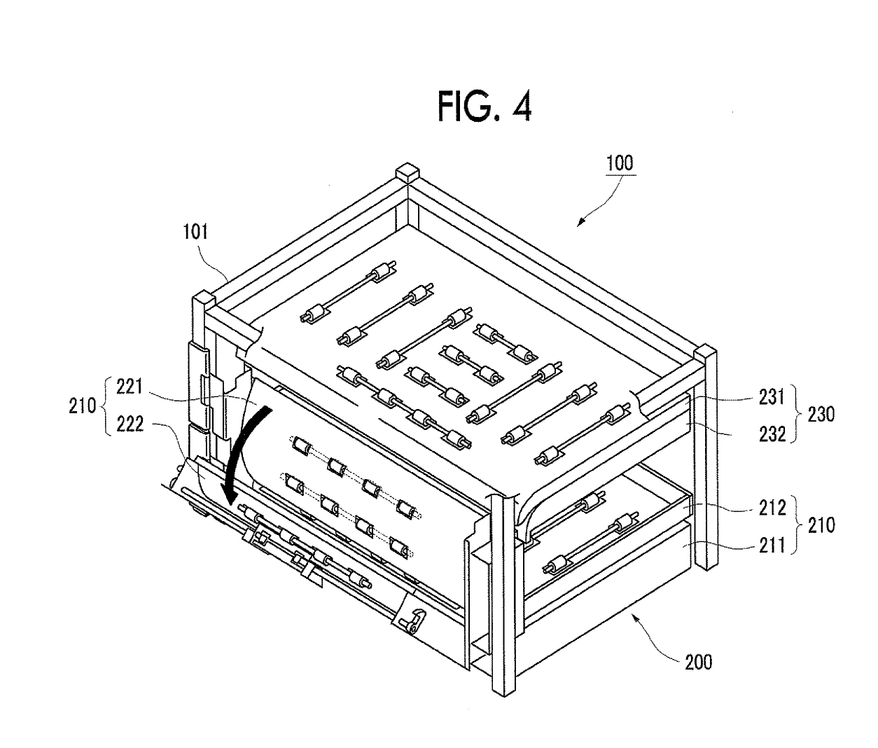

Additionally, the reversal section 220 includes a first reversal guide plate 221 (see FIGS. 4 to 8 to be described below) and a second reversal guide plate 222 that are arranged to face each other so as to form the reversal path Rb. In this example, the second reversal guide plate 222 is located outside the first reversal device 100 as seen from the first reversal guide plate 221, and the above-described space is formed on the side edge of the second reversal guide plates 222 that becomes the side opposite to the first reversal guide plate 221.

Moreover, the carrying-out section 230 includes a first carrying-out guide plate 231 and a second carrying-out guide plate 232 that are arranged to face each other to form the carrying-out path Rc. In this example, the first carrying-out guide plate 231 is located outside (above) the first reversal device 100 as seen from the second carrying-out guide plate 232, and the above-described space is formed below the second carrying-out guide plate 232. In addition, although plural feed rolls that transport a sheet P are respectively provided at the carrying-in section 210, the reversal section 220, and the carrying-out section 230, respectively, the details thereof will be described below.

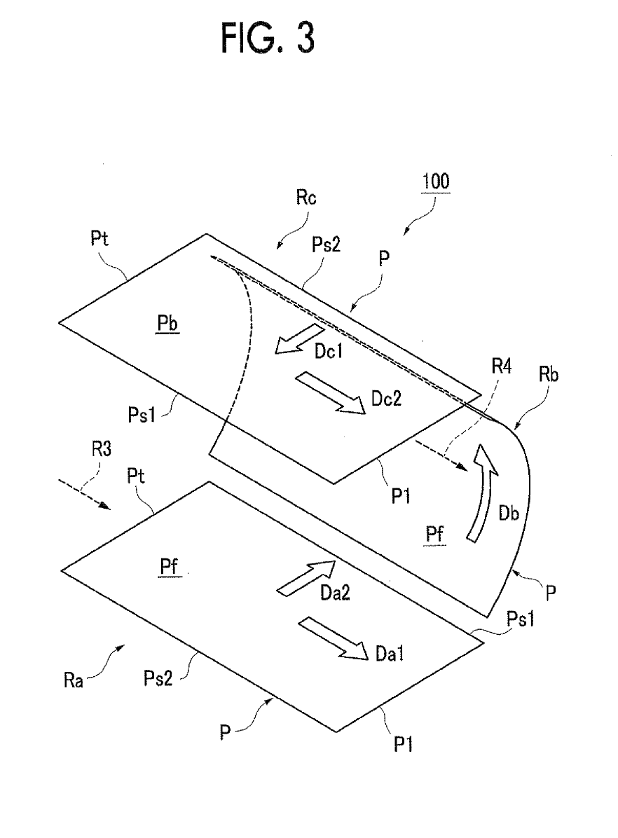

FIG. 3 is a view illustrating the relationship between respective transporting paths provided in the first reversal device 100 and transporting directions of a sheet P in the respective transporting paths. In addition, the respective transporting paths shown in FIG. 3 correspond to a case where the first reversal device 100 shown in FIG. 2 is obliquely seen from the rear edge.

Here, in the present exemplary embodiment, respective portions of the sheet P that passes through the first reversal device 100 are defined as follows. First, rectangular plain sheet is used as an example of the sheet P, and in the sheet P carried in to the carrying-in path Ra from the third transporting path R3, the lead thereof in the transporting direction is referred to as a sheet leading edge P1, and the trail thereof in the transporting direction is referred to as a sheet trailing edge Pt. Additionally, in the sheet P carried in to the carrying-in path Ra from the third transporting path R3, the left lateral edge thereof in the transporting direction is referred to as a sheet first lateral edge Ps1, and the right lateral edge thereof in the transporting direction is referred to as sheet second lateral edge Ps2. Moreover, in the sheet P carried in to the carrying-in path Ra from the third transporting path R3, the surface thereof that is turned up is referred to as a sheet front surface Pf, and the surface that is turned down is referred to as a sheet back surface Pb. In addition, in this example, a secondary transfer surface formed by the secondary transfer device 30 becomes the sheet back surface Pb, and the other surface becomes the sheet front surface Pf.

Here, in the present exemplary embodiment, the sheet leading edge P1 corresponds to a leading edge, the sheet trailing edge Pt corresponds to a rear edge, the sheet first lateral edge Ps1 corresponds to a first side edge, and the sheet second lateral edge Ps2 corresponds to a second side edge.

A sheet P is sent into the carrying-in path Ra from the third transporting path R3 along a carrying-in direction Da1 that follows the sheet first lateral edge Ps1 and the sheet second lateral edge Ps2, with the sheet front surface Pf turned up, the sheet leading edge P1 as a lead, and the sheet trailing edge Pt as a trail. Additionally, a sheet P is sent out to the reversal path Rb from the carrying-in path Ra along a transfer direction Da2 that follows the sheet leading edge P1 and the sheet trailing edge Pt, with the sheet front surface Pf turned up, the sheet first lateral edge Ps1 as a lead, and the sheet second lateral edge Ps2 as a trail.

A sheet P is sent into the reversal path Rb from the carrying-in path Ra along a reversal direction Db that follows the sheet leading edge P1 and the sheet trailing edge Pt, with the sheet front surface Pf turned up, the sheet first lateral edge Ps1 as a lead, and the sheet second lateral edge Ps2 as a trail. In addition, the transfer direction Da2 and the reversal direction Db are the same direction at a boundary portion between the carrying-in path Ra and the reversal path Rb. Here, the reversal direction Db is formed in a curved shape (U-shape), and the sheet P transported within the reversal path Rb is transported in a state where the relationship between the sheet first lateral edge Ps1 and the sheet second lateral edge Ps2 as seen from above is reversed, and the relationship between the front and back (the sheet front surface Pf and the sheet back surface Pb) is reversed. Thereby, a sheet P is sent out from the reversal path Rb along the reversal direction Db that follows the sheet leading edge P1 and the sheet trailing edge Pt, with the sheet back surface Pb turned up, the sheet first lateral edge Ps1 as a lead, and the sheet second lateral edge Ps2 as a trail.

A sheet P is sent into the carrying-out path Rc from the reversal path Rb along a receiving direction Dc1 that follows the sheet leading edge P1 and the sheet trailing edge Pt, with the sheet back surface Pb turned up, the sheet first lateral edge Ps1 as a lead, and the sheet second lateral edge Ps2 as a trail. In addition, the reversal direction Db and the receiving direction Dc1 are the same direction at a boundary portion between the reversal path Rb and the carrying-out path Rc. Additionally, a sheet P is sent out to the fourth transporting path R4 from the carrying-out path Rc along a carrying-out direction Dc2 that follows the sheet first lateral edge Ps1 and the sheet second lateral edge Ps2, with the sheet back surface Pb turned up, the sheet leading edge P1 as a lead, and the sheet trailing edge Pt as a trail.

As such, in the first reversal device 100 of the present exemplary embodiment, the traveling direction of the sheet P supplied from the third transporting path R3 is changed by 90° in the carrying-in path Ra, and the sheet P is supplied to the reversal path Rb. Then, the sheet P supplied from the carrying-in path Ra is rotated by 180° in the reversal path Rb, and the sheet P of which the front and back are reversed is supplied to the carrying-out path Rc. Then, the traveling direction of the sheet P supplied from the reversal path Rb is changed by 90° in the carrying-out path Rc, and the sheet P is supplied to the fourth transporting path R4. At this time, the carrying-in direction Da1 in the carrying-in path Ra and the carrying-out direction Dc2 in the carrying-out path Rc are the same direction. The relationship between the sheet leading edge P1 and the sheet trailing edge Pt with respect to the transporting direction does not change before and after the passage of a sheet P through the first reversal device 100, while the relationship between the sheet first lateral edge Ps1 and the sheet second lateral edge Ps2 with respect to the transporting direction is reversed, whereby the sheet front surface Pf and the sheet back surface Pb are reversed.

Next, a more detailed configuration of the first reversal device 100 will be described.

FIG. 4 is a perspective view when the second reversal guide plate 222 is further set to an open state in the first reversal device 100 shown in FIG. 2.

In the present exemplary embodiment, in the reversal section 220 that constitutes the first reversal device 100, the second reversal guide plate 222 is provided so as to be openable and closable with respect to the first reversal guide plate 221. Here, the second reversal guide plate 222 rotates, with a lower side that becomes the carrying-in section 210 side as an axis. For this reason, in the reversal section 220, the second reversal guide plate 222 is opened with respect to the first reversal guide plate 221, whereby the reversal path Rb (refer to FIG. 2) formed by the first and second reversal guide plates 221 and 222 is exposed to the near side of the first reversal device 100 and the image forming apparatus 1 (refer to FIG. 1) in an upwardly spread state.

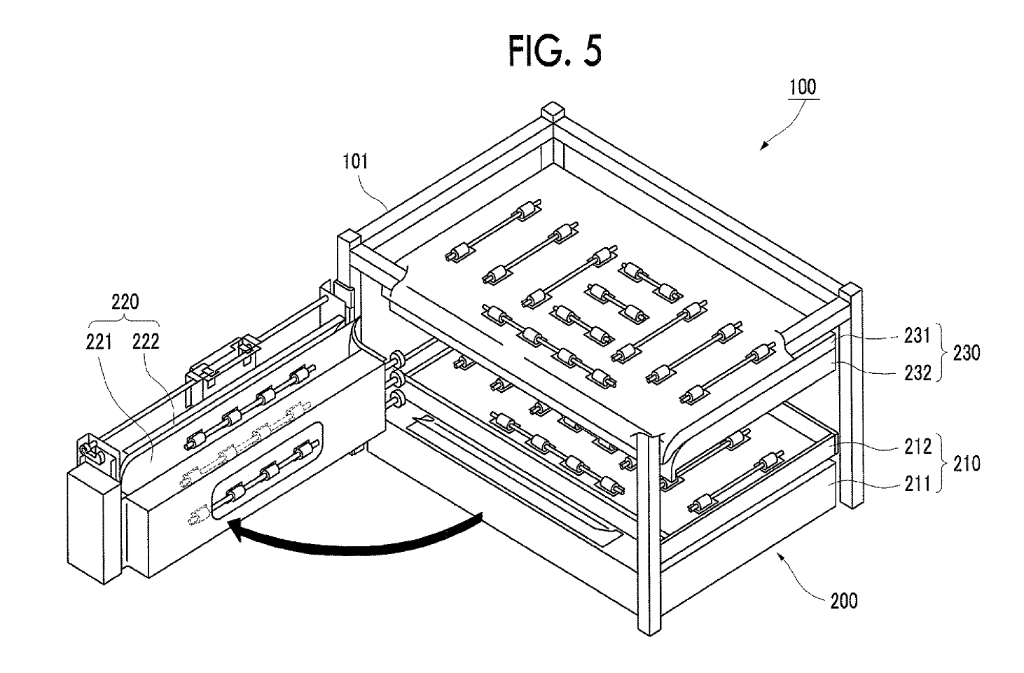

FIG. 5 is a perspective view when the reversal section 220 is further set to an open state in the first reversal device 100 shown in FIG. 2.

In the present exemplary embodiment, the reversal section 220 itself that constitutes the first reversal device 100 is provided so as to be openable and closable with respect to the frame body 101. Here, the reversal section 220 rotates with a strut provided on the near side of the frame body 101 and the rear edge in the drawing as an axis. For this reason, in the first reversal device 100, the reversal section 220 is opened with respect to the frame body 101, whereby the space formed between the carrying-in section 210 and the carrying-out section 230 in the first reversal device 100 is exposed to the near side of the first reversal device 100 and the image forming apparatus 1 (refer to FIG. 1).

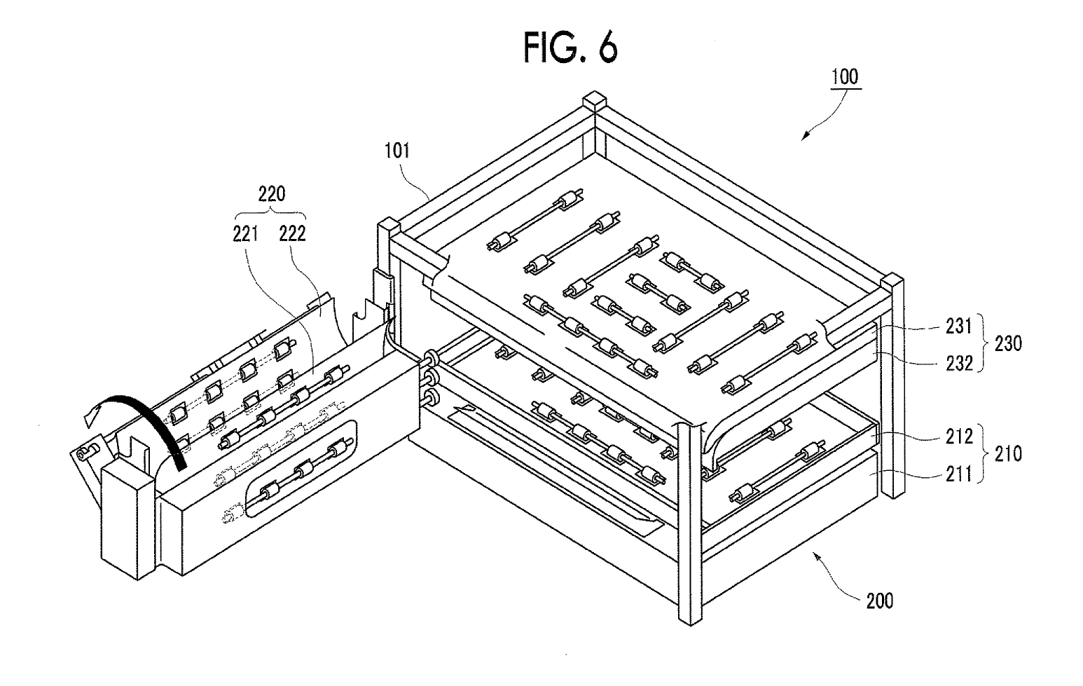

FIG. 6 is a perspective view when the second reversal guide plate 222 is further set to an open state in the first reversal device 100 shown in FIG. 5.

In this way, in the first reversal device 100 of the present exemplary embodiment, the second reversal guide plate 222 may be opened with respect to the first reversal guide plate 221 in the reversal section 220 after the reversal section 220 is opened to the frame body 101.

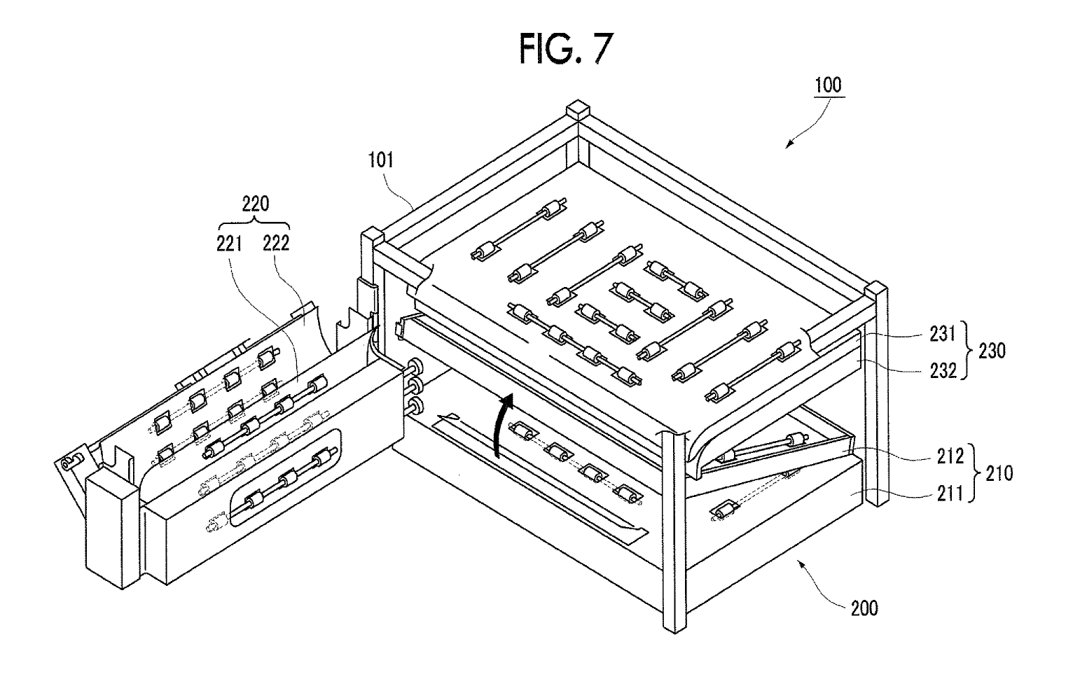

FIG. 7 is a perspective view when the second carrying-in guide plate 212 is further set to an open state in the first reversal device 100 shown in FIG. 6.

In the present exemplary embodiment, in the carrying-in section 210 that constitutes the first reversal device 100, the second carrying-in guide plate 212 is provided so as to be openable and closable with respect to the first carrying-in guide plate 211 fixed to the frame body 101. Here, the second carrying-in guide plate 212 rotates with the rear edge of the first reversal device 100 that becomes the rear edge in the image forming apparatus 1 shown in FIG. 1 as an axis. For this reason, in the first reversal device 100 in which the reversal section 220 is set to an open state, the second carrying-in guide plate 212 is opened with respect to the first carrying-in guide plate 211, whereby the carrying-in path Ra (refer to FIG. 2) formed by the first and second carrying-in guide plates is exposed to the near side of the first reversal device 100 and the image forming apparatus 1 in a forwardly spread state.

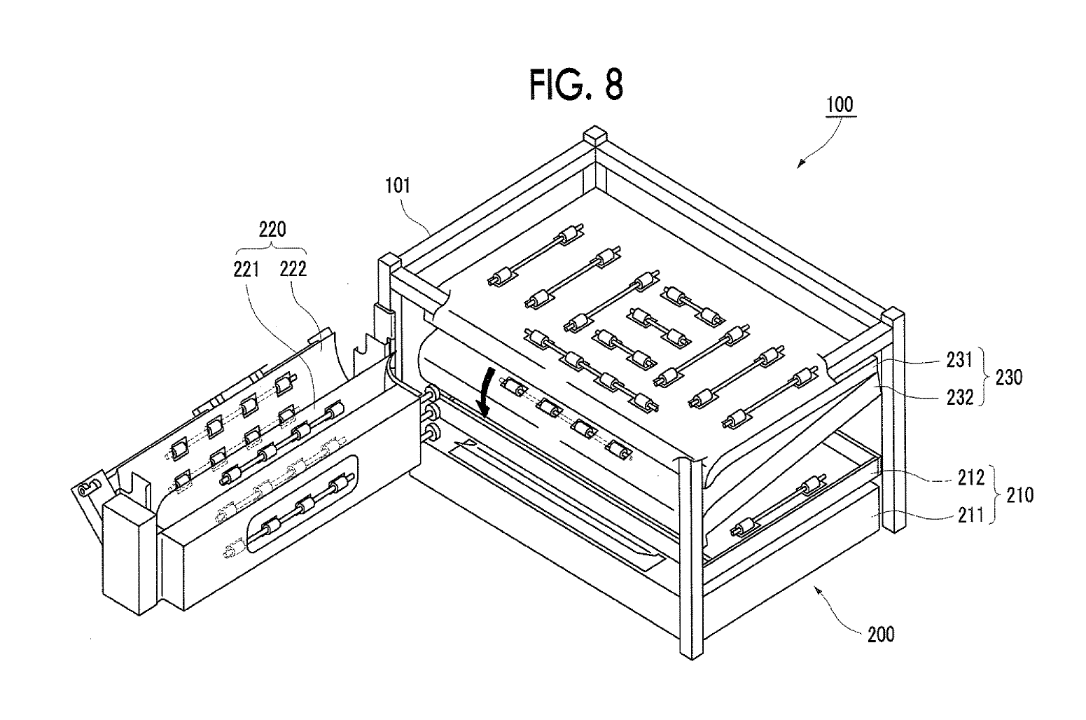

FIG. 8 is a perspective view when the second carrying-out guide plate 232 is further set to an open state in the first reversal device 100 shown in FIG. 6.

In the present exemplary embodiment, in the carrying-out section 230 that constitutes the first reversal device 100, the second carrying-out guide plate 232 is provided so as to be openable and closable with respect to the first carrying-out guide plate 231 fixed to the frame body 101. Here, the second carrying-out guide plate 232 rotates, with the rear edge of the first reversal device 100 that becomes the rear edge in the image forming apparatus 1 shown in FIG. 1 as an axis. For this reason, in the first reversal device 100 in which the reversal section 220 is set to an open state, the second carrying-out guide plate 232 is opened with respect to the first carrying-out guide plate 231, whereby the carrying-out path Rc (refer to FIG. 2) formed by the first and second carrying-out guide plates is exposed to the near side of the first reversal device 100 and the image forming apparatus 1 in a forwardly spread state.

Accordingly, when jamming of a sheet P occurs in the reversal section 220, the jammed sheet P may be removed, for example, by setting the first reversal device 100 to the state shown in FIG. 4. Additionally, when jamming of a sheet P occurs in the carrying-in section 210, the jammed sheet P may be removed, for example, by setting the first reversal device 100 to the state shown in FIG. 7. Moreover, when jamming of a sheet P occurs in the carrying-out section 230, the jammed sheet P may be removed, for example, by setting the first reversal device 100 to the state shown in FIG. 8. When removal of these jamming is performed, a user just has to manipulate the respective parts of the first reversal device 100 from the near side of the image forming apparatus 1.

In addition, a mechanism (not shown) for fixing the second carrying-in guide plate 212 to the first carrying-in guide plate 211 is attached to the carrying-in section 210, a mechanism (not shown) for fixing the second reversal guide plate 222 to the first reversal guide plate 221 is attached to the reversal section 220, and a mechanism (not shown) for fixing the second carrying-out guide plate 232 to the first carrying-out guide plate 231 is attached to the carrying-out section 230.

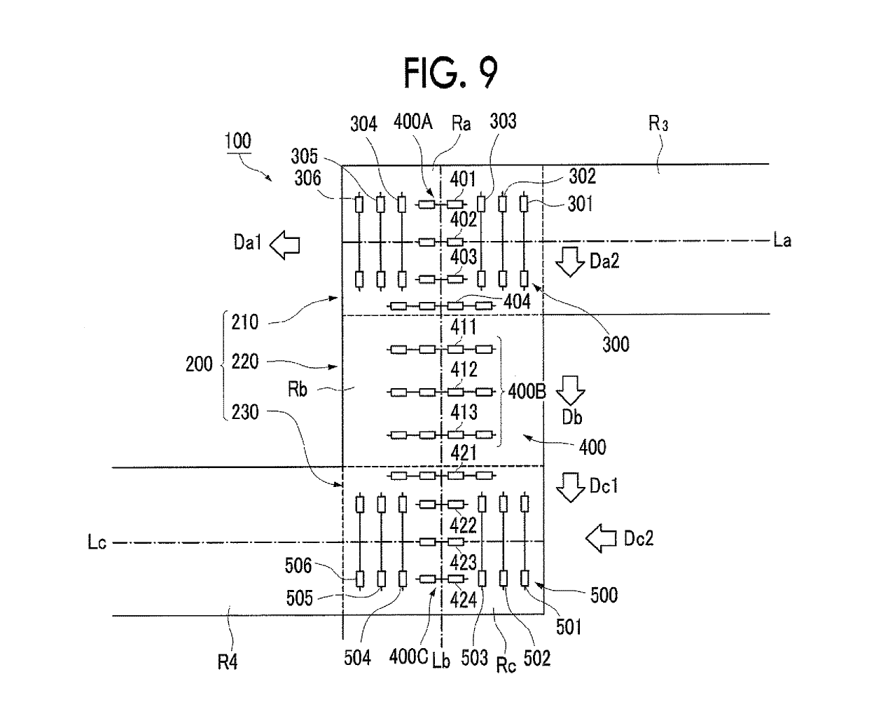

FIG. 9 is a view illustrating the configuration of the respective transporting paths and the respective transport parts in the first reversal device 100 of the present exemplary embodiment. In addition, FIG. 9 shows a state where the carrying-in path Ra, the reversal path Rb, and the carrying-out path Rc in the first reversal device 100 are developed on a plane.

The first reversal device 100 includes a carrying-in transport part 300 that is provided at the carrying-in section 210 to transport a sheet P along the carrying-in direction Da1, and an upstream reversal transport part 400A that is provided at the carrying-in section 210 to transport a sheet P along the transfer direction Da2. Additionally, the first reversal device 100 includes a midstream reversal transport part 400B that is provided at the reversal section 220 to transport a sheet P along the reversal direction Db. Moreover, the first reversal device 100 includes a downstream reversal transport part 400C that is provided at the carrying-out section 230 to transport a sheet P along the receiving direction Dc1, and a carrying-out transport part 500 that is provided at the carrying-out section 230 to transport a sheet P along the carrying-out direction Dc2. In addition, in the present exemplary embodiment, the upstream reversal transport part 400A provided at the carrying-in section 210, the midstream reversal transport part 400B provided at the reversal section 220, and the downstream reversal transport part 400C provided at the carrying-out section 230 are collectively referred to as a reversal transport part 400.

Among them, the carrying-in transport part 300 provided at the carrying-in section 210 includes a first carrying-in roll pair 301 nearest to the third transporting path R3, a second carrying-in roll pair 302, a third carrying-in roll pair 303, a fourth carrying-in roll pair 304, a fifth carrying-in roll pair 305, and a sixth carrying-in roll pair 306, in order from the upstream side in the carrying-in direction Da1. In contrast, the upstream reversal transport part 400A provided at the carrying-in section 210 includes an upstream first reversal roll pair 401, an upstream second reversal roll pair 402, an upstream third reversal roll pair 403, and an upstream fourth reversal roll pair 404 nearest to the reversal path Rb as an example of a pair of rotary bodies, in order from the upstream side in the transfer direction Da2.

Additionally, the midstream reversal transport part 400B provided at the reversal section 220 includes a midstream first reversal roll pair 411 nearest to the carrying-in path Ra, a midstream second reversal roll pair 412, and a midstream third reversal roll pair 413 nearest to the carrying-out path Rc, in order from the upstream side in the reversal direction Db.

Moreover, the downstream reversal transport part 400C provided at the carrying-out section 230 includes a downstream first reversal roll pair 421 as an example of a pair of rotary bodies nearest to the reversal path Rb, a downstream second reversal roll pair 422, a downstream third reversal roll pair 423, and a downstream fourth reversal roll pair 424, in order from the upstream side in the receiving direction Dc1. In contrast, the carrying-out transport part 500 provided at the carrying-out section 230 includes a first carrying-out roll pair 501, a second carrying-out roll pair 502, a third carrying-out roll pair 503, a fourth carrying-out roll pair 504, a fifth carrying-out roll pair 505, and a sixth carrying-out roll pair 506 nearest to the fourth transporting path R4, in order from the upstream side in the carrying-out direction Dc2.

In the carrying-in path Ra, the upstream first reversal roll pair 401 to the upstream third reversal roll pair 403 that constitute the upstream reversal transport part 400A are arranged between the third carrying-in roll pair 303 and the fourth carrying-in roll pair 304 that constitute the carrying-in transport part 300. In contrast, in the carrying-out path Rc, the downstream second reversal roll pair 422 to the downstream fourth reversal roll pair 424 that constitute the downstream reversal transport part 400C are arranged between the third carrying-out roll pair 503 and the fourth carrying-out roll pair 504 that constitute the carrying-out transport part 500.

Here, in the present exemplary embodiment, in the transport of a sheet P from the third transporting path R3 to the carrying-in path Ra, the middle position of the sheet first lateral edge Ps1 and the sheet second lateral edge Ps2 of the sheet P transported (both refer to FIG. 2) is made to coincide with a carrying-in direction transport reference line La set in the shape of a straight line with respect to the third transporting path R3 and the carrying-in path Ra. In the carrying-in path Ra, the first carrying-in roll pair 301 to the sixth carrying-in roll pair 306 that constitute the carrying-in transport part 300 are arranged, respectively, so as to straddle the carrying-in direction transport reference line La.

Additionally, in the present exemplary embodiment, in the transport of a sheet P from the carrying-in path Ra via the reversal path Rb to the carrying-out path Rc, the middle position of the sheet leading edge 21 and the sheet trailing edge Pt of the sheet P transported is made to coincide with a reversal direction transport reference line Lb set in the shape of a straight line with respect to the carrying-in path Ra, the reversal path Rb, and the carrying-out path Rc. In the carrying-in path Ra, the upstream first reversal roll pair 401 to the upstream fourth reversal roll pair 404 that constitute the upstream reversal transport part 400A are arranged, respectively so as to straddle the reversal direction transport reference line Lb. Moreover, in the reversal path Rb, the midstream first reversal roll pair 411 to the midstream third reversal roll pair 413 that constitute the midstream reversal transport part 400B are arranged, respectively, so as to straddle the reversal direction transport reference line Lb. Moreover, in the carrying-out path Rc, the downstream first reversal roll pair 421 to the downstream fourth reversal roll pair 424 that constitute the downstream reversal transport part 400C are arranged, respectively, so as to straddle the reversal direction transport reference line Lb.

Moreover, in the present exemplary embodiment, in the transport of a sheet P from the carrying-out path Rc to the fourth transporting path R4, the middle position of the sheet first lateral edge Ps1 and the sheet second lateral edge Ps2 of the sheet P transported (both refer to FIG. 2) is made to coincide with a carrying-out direction transport reference line Lc set in the shape of a straight line with respect to the fourth transporting path R4 and the carrying-out path Rc. In the carrying-out path Rc, the first carrying-out roll pair 501 to the sixth carrying-out roll pair 506 that constitute the carrying-out transport part 500 are arranged, respectively, so as to straddle the carrying-out direction transport reference line Lc.

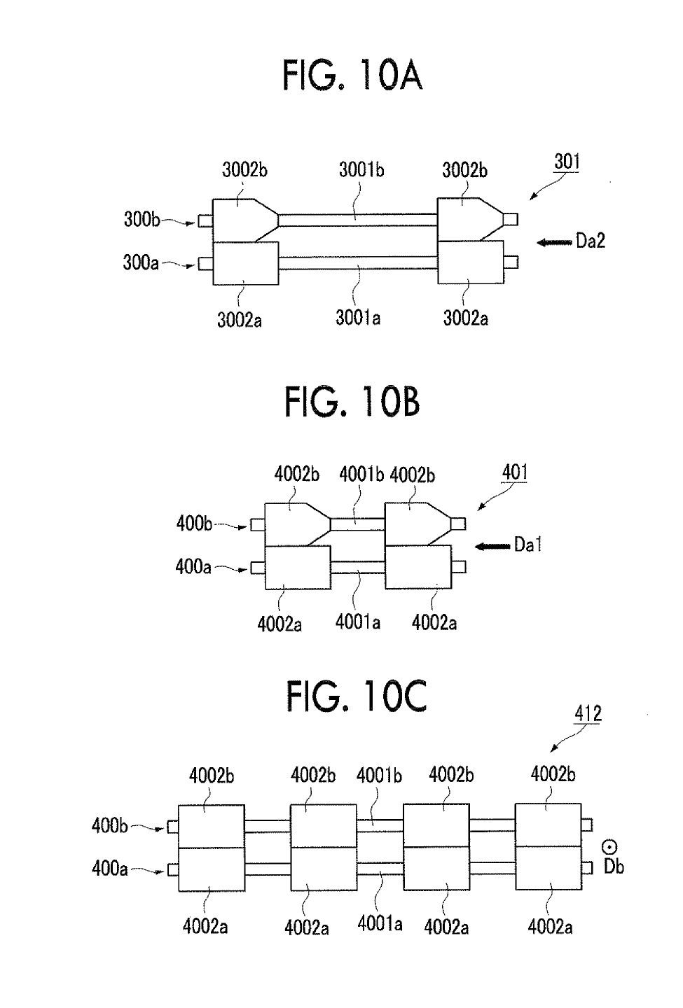

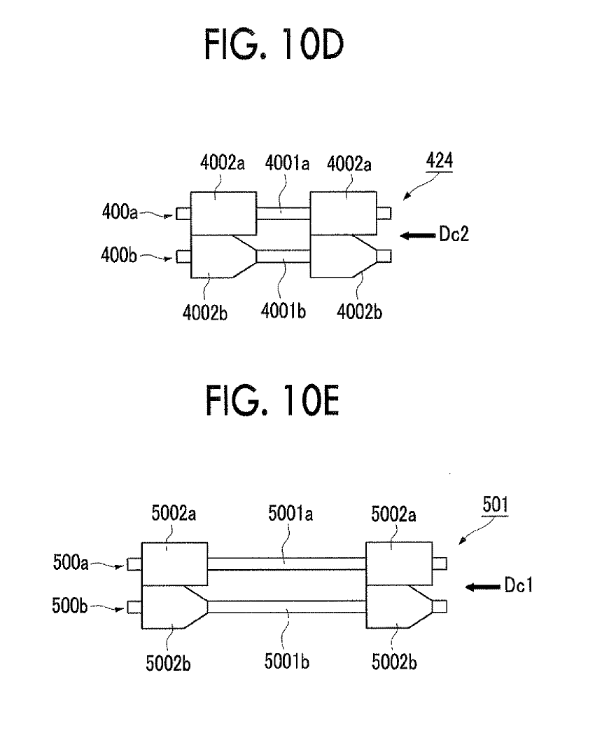

FIGS. 10A to 10E are views illustrating the configuration of feed roll pairs provided in the respective transport parts of the first sheet reversal device 100. Here, FIG. 10A, shows an example of the configuration of the first carrying-in roll pair 301 in the carrying-in transport part 300 provided at the carrying-in section 210. Additionally, FIG. 10B shows an example of the configuration of the upstream first reversal roll pair 401 in the upstream reversal transport part 400A provided at the carrying-in section 210. Moreover, FIG. 10C shows an example of the configuration of the midstream second reversal roll pair 412 in the midstream reversal transport part 400B provided at the reversal section 220. Furthermore, FIG. 10D shows an example of the configuration of the downstream fourth reversal roll pair 424 in the downstream reversal transport part 400C provided at the carrying-out section 230. FIG. 10E shows an example of the configuration of the first carrying-out roll pair 501 in the carrying-out transport part 500 provided at the carrying-out section 230.

As shown in FIG. 10A, the first carrying-in roll pair 301 that constitutes the carrying-in transport part 300 includes a carrying-in driving roll 300a that rotates under the driving from the outside, and a carrying-in driven roll 300b that is arranged to face the carrying-in driving roll 300a and rotates with the rotation of the carrying-in driving roll 300a. Additionally, the second carrying-in roll pair 302 to the sixth carrying-in roll pair 306 that constitute the carrying-in transport part 300 also include a carrying-in driving roll 300a and the carrying-in driven roll 300b, respectively. In the present exemplary embodiment, each of the carrying-in driving rolls 300a that constitute the first carrying-in roll pair 301 to the sixth carrying-in roll pair 306 is attached to the first carrying-in guide plate 211 (refer to FIG. 2) that becomes a fixed side in the carrying-in section 210 (refer to FIG. 2), and each of the carrying-in driven rolls 300b that constitute the first carrying-in roll pair 301 to the sixth carrying-in roll pair 306 is attached to the second carrying-in guide plate 212 (refer to FIG. 2) that becomes a movable side (openable and closable side) in the carrying-in section 210.

Here, the carrying-in driving roll 300a includes a shaft 3001a that is made of metal and extends along the transfer direction Da2 in the carrying-in path Ra (refer to FIG. 9), and two rubber rolls 3002a that are attached to the shaft 3001a. In the carrying-in driving roll 300a, the rubber rolls 3002a have a cylindrical shape, respectively.

In contrast, the carrying-in driven roll 300b includes a shaft 3001b that is made of metal and extends along the transfer direction Da2 in the carrying-in path Ra (refer to FIG. 9), and two resin rolls 3002b that are attached to the shaft 3001b at positions that respectively face the two rubber rolls 3002a provided at the carrying-in driving roll 300a. In the carrying-in driven roll 300b, each resin roll 3002b has a cylindrical shape at one end that becomes the downstream side in the transfer direction Da2, and has a tapered shape (taper portion) at the other end that becomes the upstream side in the transfer direction Da2.

As shown in FIG. 10B, the upstream first reversal roll pair 401 that constitutes the upstream reversal transport part 400A includes a reversal driving roll 400a that rotates under the driving from the outside, and a reversal driven roll 400b that is arranged to face the reversal driving roll 400a, and rotates with the rotation of the reversal driving roll 400a. Additionally, the upstream second reversal roll pair 402 to the upstream fourth reversal roll pair 404 that constitute the upstream reversal transport part 400A also include the reversal driving roll 400a and the reversal driven roll 400b, respectively. In the present exemplary embodiment, each of the reversal driving rolls 400a that constitute the upstream first reversal roll pair 401 to the upstream fourth reversal roll pair 404 is attached to the first carrying-in guide plate 211 (refer to FIG. 2) that becomes the fixed side in the carrying-in section 210 (refer to FIG. 2), and each of the reversal driven rolls 400b that constitute the upstream first reversal roll pair 401 to the upstream fourth reversal roll pair 404 is attached to the second carrying-in guide plate 212 (refer to FIG. 2) that becomes the movable side (openable and closable side) in the carrying-in section 210 (refer to FIG. 2).

Here, the reversal driving roll 400a in the upstream side reversal transport part 400A has a shaft 4001a that is made of metal and extends along the carrying-in direction Da1 in the carrying-in path Ra (refer to FIG. 9), and two rubber rolls 4002a that are attached to the shaft 4001a. In the reversal driving roll 400a in the upstream reversal transport part 400A, the rubber rolls 4002a have a cylindrical shape, respectively.

In contrast, the reversal driven roll 400b in the upstream reversal transport part 400A includes a shaft 4001b that is made of metal and extends along the carrying-in direction Da1 in the carrying-in path Ra (refer to FIG. 9), and two resin rolls 4002b that are attached to the shaft 4001b at positions that respectively face the two rubber rolls 4002a provided at the reversal driving roll 400a. In the reversal driven roll 400b in the upstream reversal transport part 400A, each resin roll 4002b has a cylindrical shape at one end that becomes the downstream side in the carrying-in direction Da1, and has a tapered shape (taper portion) at the other end that becomes the upstream side in the carrying-in direction Da1.

In addition, in the upstream fourth reversal roll pair 404, four rubber rolls 4002a are attached to one shaft 4001a in the reversal driving roll 400a, and four resin rolls 4002b are attached to one shaft 4001b in the reversal driven roll 400b.

As shown in FIG. 10C, the midstream second reversal roll pair 412 that constitutes the midstream reversal transport part 4008 includes a reversal driving roll 400a that rotates under the driving from the outside, and a reversal driven roll 400b that is arranged to face the reversal driving roll 400a, and rotates with the rotation of the reversal driving roll 400a. Additionally, the midstream first reversal roll pair 411 and the midstream third reversal roll pair 413 that constitute the midstream reversal transport part 400B include the reversal driving roll 400a and the reversal driven roll 400b, respectively. In the present exemplary embodiment, each of the reversal driving rolls 400a that constitute the midstream first reversal roll pair 411 to the midstream third reversal roll pair 413 is attached to the first reversal guide plate 221 (refer to FIG. 2) that becomes a fixed side in the reversal section 220 (refer to FIG. 2), and each of the reversal driven rolls 400b that constitute the midstream first reversal roll pair 411 to the midstream third reversal roll pair 413 is attached to the second reversal guide plate 222 (refer to FIG. 2) that becomes a movable side (operable and closable side) in the reversal section 220 (refer to FIG. 2).

Here, the reversal driving roll 400a in the midstream reversal transport part 400B includes a shaft 4001a that is made of metal, intersects the reversal direction Db in the reversal path Rb (refer to FIG. 9), and extends along the carrying-in direction Da1 and the carrying-out direction Dc2, and four rubber rolls 4002a that are attached to the shaft 4001a. In the reversal driving roll 400a in the midstream reversal transport part 400B, the rubber rolls 4002a have a cylindrical shape, respectively.

In contrast, the reversal driven roll 400b in the midstream reversal transport part 400B includes a shaft 4001b that is made of metal, intersects the reversal direction Db in the reversal path Rb, and extends along the carrying-in direction Da1 and the carrying-out direction Dc2, and four resin rolls 4002b that are attached to the shaft 4001b at positions that respectively face the four rubber rolls 4002a provided at the reversal driving roll 400a. In the reversal driven roll 400b in the midstream reversal transport part 400B, the resin rolls 4002b have a cylindrical shape, respectively.

As shown in FIG. 10D, the downstream fourth reversal roll pair 424 that constitutes the downstream reversal transport part 400C includes a reversal driving roll 400a that rotates under the driving from the outside, and a reversal driven roll 400b that is arranged to face the reversal driving roll 400a, and rotates with the rotation of the reversal driving roll 400a. Additionally, the downstream first reversal roll pair 421 to the downstream third reversal roll pair 423 that constitute the downstream reversal transport part 400C also include the reversal driving roll 400a and the reversal driven roll 400b, respectively. In the present exemplary embodiment, each of the reversal driving rolls 400a that constitute the downstream first reversal roll pair 421 to the downstream fourth reversal roll pair 424 is attached to the first carrying-out guide plate 231 (refer to FIG. 2) that becomes a fixed side in the carrying-out section 230 (refer to FIG. 2), and each of the reversal driven rolls 400b that constitute the downstream first reversal roll pair 421 to the downstream fourth reversal roll pair 424 is attached to the second carrying-out guide plate 232 (refer to FIG. 2) that becomes a movable side (openable and closable side) in the carrying-out section 230 (refer to FIG. 2).

Here, the reversal driving roll 400a in the downstream reversal transport part 400C has a shaft 4001a that is made of metal and extends along the carrying-out direction Dc2 in the carrying-out path Rc (refer to FIG. 9), and two rubber rolls 4002a that are attached to the shaft 4001a. In the reversal driving roll 400a in the downstream reversal transport part 400C, the rubber rolls 4002a have a cylindrical shape, respectively.

In contrast, the reversal driven roll 400b in the downstream reversal transport part 400C includes a shaft 4001b that is made of metal and extends along the carrying-out direction Dc2 in the carrying-out path Rc (refer to FIG. 9), and two resin rolls 4002b that are attached to the shaft 4001b at positions that respectively face the two rubber rolls 4002a provided at the reversal driving roll 400a. In the reversal driven roll 400b in the downstream reversal transport part 400C, each resin roll 4002b has a cylindrical shape at one end that becomes the downstream side in the carrying-out direction Dc2, and has a tapered shape (taper portion) at the other end that becomes the upstream side in the carrying-out direction Dc2. In addition, in the downstream first reversal roll pair 421, four rubber rolls 4002a are attached to one shaft 4001a in the reversal driving roll 400a, and four resin rolls 4002b are attached to one shaft 4001b in the reversal driven roll 400b.

As shown in FIG. 10E, the first carrying-out roll pair 501 that constitutes the carrying-out transport part 500 includes a carrying-out driving roll 500a that rotates under the driving from the outside, and a carrying-out driven roll 500b that is arranged to face the carrying-out driving roll 500a, and rotates with the rotation of the carrying-out driving roll 500a. Additionally, the second carrying-out roll pair 502 to the sixth carrying-out roll pair 506 that constitute the carrying-out transport part 500 include a carrying-out driving roll 500a and a carrying-out driven roll 500b, respectively. In the present exemplary embodiment, each of the carrying-out driving rolls 500a that constitute the first carrying-out roll pair 501 to the sixth carrying-out roll pair 506 is attached to the first carrying-out guide plate 231 (refer to FIG. 2) that becomes the fixed side in the carrying-out section 230 (refer to FIG. 2), and each of the carrying-out driven rolls 500b that constitute the first carrying-out roll pair 501 to the sixth carrying-out roll pair 506 is attached to the second carrying-out guide plate 232 (refer to FIG. 2) that becomes the movable side (openable and closable side) in the carrying-out section 230 (refer to FIG. 2).

Here, the carrying-out driving roll 500a includes a shaft 5001a that is made of metal and extends along the receiving direction Dc1 in the carrying-out path Rc (refer to FIG. 9), and two rubber rolls 5002a attached to the shaft 5001a. In the carrying-out driving roll 500a, the rubber rolls 5002a have a cylindrical shape, respectively.

In contrast, the carrying-out driven roll 500b includes a shaft 5001b that is made of metal and extends along the receiving direction Dc1 in the carrying-out path Rc (refer to FIG. 9), and two resin rolls 5002b that are attached to the shaft 5001b at positions that respectively face the two rubber rolls 5002a provided at the carrying-out driving roll 500a. In the carrying-out driven roll 500b, in each resin roll 5002b has a cylindrical shape at one end that becomes the downstream side in the receiving direction Dc1, has a tapered shape (taper portion) at the other end that becomes the upstream side in the receiving direction Dc1.

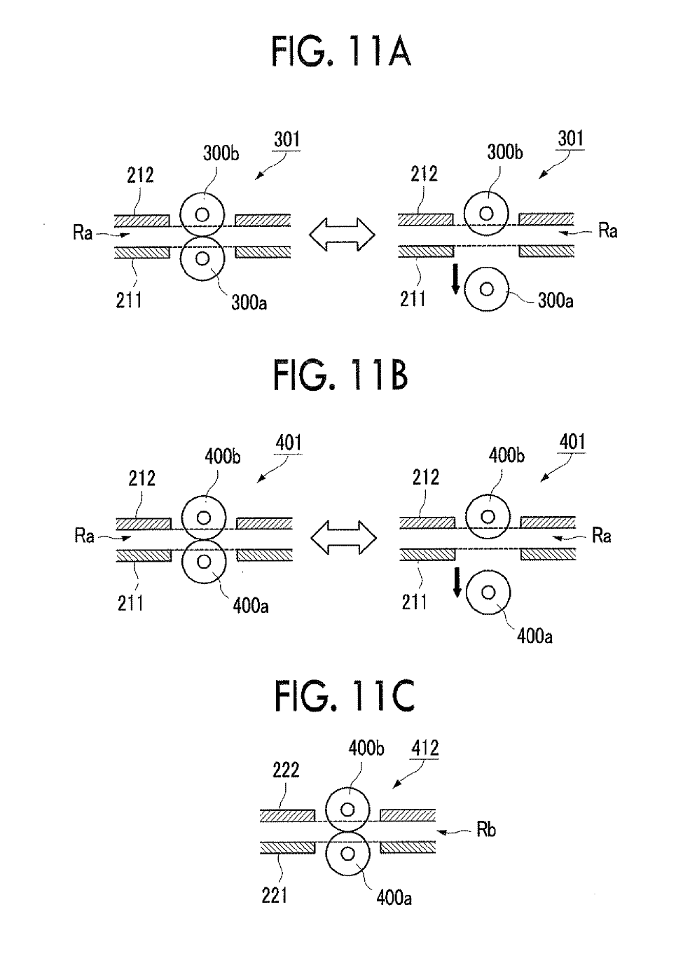

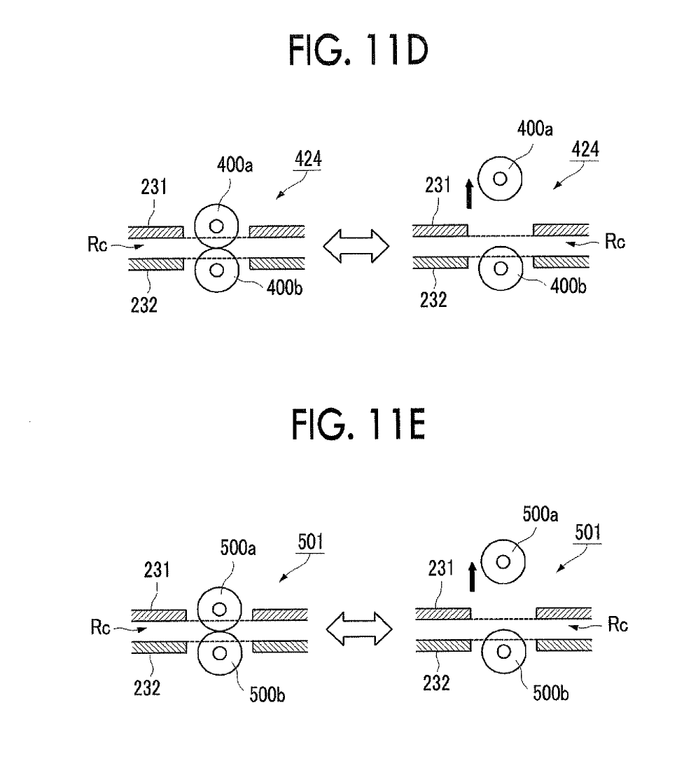

FIG. 11 is a view illustrating the configuration between the respective transporting paths and the respective transport roll pairs in the first reversal device 100 of the present exemplary embodiment. Here, FIGS. 11A to 11E correspond to FIGS. 10A to 10E, respectively. That is, FIG. 11A shows the relationship between the carrying-in path Ra and the first carrying-in roll pair 301 in the carrying-in section 210. Additionally, FIG. 11B shows the relationship between the carrying-in path Ra and the upstream first reversal roll pair 401 in the carrying-in section 210. Moreover, FIG. 11C shows the relationship between the reversal path Rb and the midstream second reversal roll pair 412 in the reversal section 220. Furthermore, FIG. 11D shows the relationship between the carrying-out path Rc and the downstream fourth reversal roll pair 424 in the carrying-out section 230. Also, FIG. 11E shows the relationship between the carrying-out path Rc and the first carrying-out roll pair 501 in the carrying-out section 230.

As shown in FIG. 11A, the carrying-in driving roll 300a and the carrying-in driven roll 300b that constitute the first carrying-in roll pair 301 are configured so as to be allowed to come into contact with each other and separate from each other. When the first carrying-in roll pair 301 is brought into contact, both the carrying-in driving roll 300a and the carrying-in driven roll 300b are brought into the state of having advanced to the carrying-in path Ra. In contrast, when the first carrying-in roll pair 301 is separated, the carrying-in driving roll 300a keeps away from the carrying-in driven roll 300b, whereby the carrying-in driven roll 300b maintains the state of having advanced to the carrying-in path Ra, while the carrying-in driving roll 300a is brought into the state of having withdrawn from the carrying-in path Ra. In addition, the second carrying-in roll pair 302 to the sixth carrying-in roll pair 306 that constitute the carrying-in transport part 300 along with the first carrying-in roll pair 301 also perform the same contacting and separating operation as the first carrying-in roll pair 301.

As shown in FIG. 11B, the reversal driving roll 400a and the reversal driven roll 400b that constitute the upstream first reversal roll pair 401 are configured so as to be allowed to come into contact with each other and separate from each other. When the upstream first reversal roll pair 401 is brought into contact, both the reversal driving roll 400a and the reversal driven roll 400b are brought into the state of having advanced to the carrying-in path Ra. In contrast, when the upstream first reversal roll pair 401 is separated, the reversal driving roll 400a keeps away from the reversal driven roll 400b, whereby the reversal driven roll 400b maintains the state of having advanced to the carrying-in path Ra, while the reversal driving roll 400a is brought into the state of having withdrawn from the carrying-in path Ra. In addition, the upstream second reversal roll pair 402 to the upstream fourth reversal roll pair 404 that constitute the upstream reversal transport part 400A along with the upstream first reversal roll pair 401 perform the same contacting and separating operation as the upstream first reversal roll pair 401.

As shown in FIG. 11C, the reversal driving roll 400a and the reversal driven roll 400b that constitute the midstream second reversal roll pair 412 are configured so as to always come into contact with each other. At this time, both reversal driving roll 400a and the reversal driven roll 400b are brought into the state of having advanced to the reversal path Rb. In addition, the midstream first reversal roll pair 411 and the midstream third reversal roll pair 413 that constitute the midstream reversal transport part 400B along with the midstream second reversal roll pair 412 are configured so as to always come into contact with each other similarly to the midstream second reversal roll pair 412.

As shown in FIG. 11D, the reversal driving roll 400a and the reversal driven roll 400b that constitute the downstream fourth reversal roll pair 424 are configured so as to be allowed to come into contact with each other and separate from each other. When the downstream fourth reversal roll pair 424 is brought into contact, both the reversal driving roll 400a and the reversal driven roll 400b are brought into the state of having advanced to the carrying-out path Rc. In contrast, when the downstream fourth reversal roll pair 424 is separated, the reversal driving roll 400a keeps away from the reversal driven roll 400b, whereby the reversal driven roll 400b maintains the state of having advanced to the carrying-out path Rc, while the reversal driving roll 400a is brought into the state of having withdrawn from the carrying-out path Rc. In addition, the downstream first reversal roll pair 421 to the downstream third reversal roll pair 423 that constitute the downstream reversal transport part 400C along with the downstream fourth reversal roll pair 424 perform the same contacting and separating operation as the downstream fourth reversal roll pair 424.

As shown in FIG. 11E, the carrying-out driving roll 500a and the carrying-out driven roll 500b that constitute the first carrying-out roll pair 501 are configured so as to be allowed to come into contact with each other and separate from each other. When the first carrying-out roll pair 501 is brought into contact, both the carrying-out driving roll 500a and the carrying-out driven roll 500b are brought into the state of having advanced to the carrying-out path Rc. In contrast, when the first carrying-out roll pair 501 is separated, the carrying-out driving roll 500a keeps away from the carrying-out driven roll 500b, whereby the carrying-out driven roll 500b maintains the state of having advanced to the carrying-out path Rc, while the carrying-out driving roll 500a is brought into the state of having withdrawn from the carrying-out path Rc. In addition, the second carrying-out roll pair 502 to the sixth carrying-out roll pair 506 that constitute the carrying-out transport part 500 along with the first carrying-out roll pair 501 also perform the same contacting and separating operation as the first carrying-out roll pair 501.

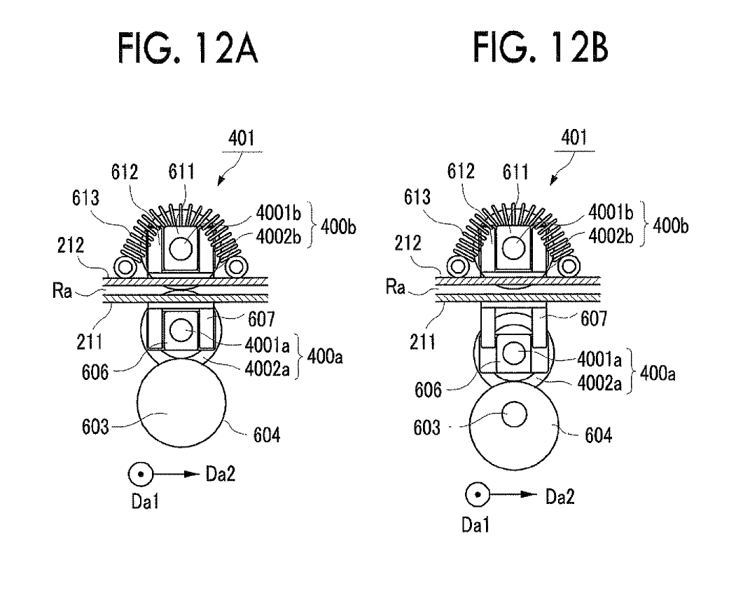

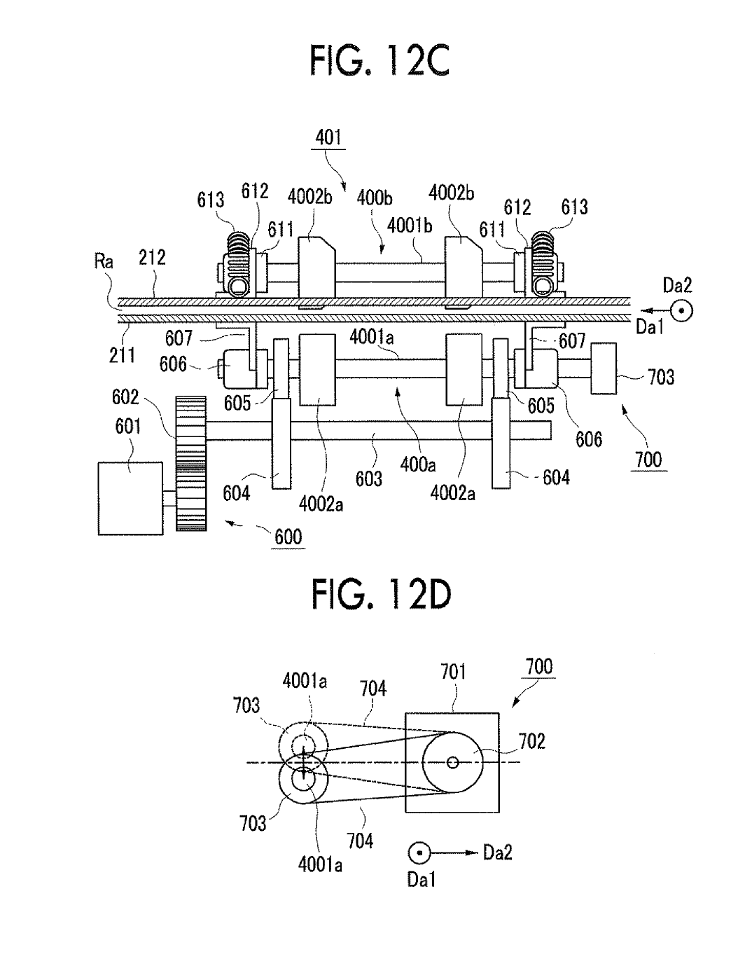

FIGS. 12A to 12D are views showing an example of the configuration of an advancing and retreating mechanism 600 that advances and retreats the upstream first reversal roll pair 401, and a rotating mechanism 700 that rotates the upstream first reversal roll pair 401. Here, FIG. 12A is a view when the upstream first reversal roll pair 401 and the advancing and retreating mechanism 600 that are set to a contact state are seen from the downstream side in the carrying-indirection Da1. Additionally, FIG. 12B is a view when the upstream first reversal roll pair 401 and the advancing and retreating mechanism 600 that are set to a separation state are seen from the downstream side in the carrying-in direction Da1. Moreover, FIG. 12C is a view when the upstream first reversal roll pair 401, the advancing and retreating mechanism 600, and the rotating mechanism 700 that are set to a separation state are seen from the downstream side in the transfer direction Da2. Furthermore, FIG. 12D is a view when the rotating mechanism 700 is seen from the downstream side in the carrying-in direction Da1.

The advancing and retreating mechanism 600 of the present exemplary embodiment includes a motor 601 for advance and retreat as an example of a drive source for advancing and retreating the reversal driving roll 400a in the upstream first reversal roll pair 401 with respect to the reversal driven roll 400b, a gear train 602 including a gear attached to a rotating shaft of the motor 601 for advance and retreat, a shaft 603 for a driving-side cam fixed and attached to one gear that constitutes the gear train 602, and driving-side cams 604 as an example of rotary members attached to the shaft 603 for a driving-side cam at two axial locations. Additionally, the advancing and retreating mechanism 600 includes ball bearings 605 attached to the shaft 4001a of the reversal driving roll 400a at positions that respectively face the two driving-side cams 604 provided at the shaft 603 for a driving-side cam, driving-side bearings 606 that are respectively attached to both ends of the shaft 4001a of the reversal driving roll 400a and rotatably supports the reversal driving roll 400a, and driving-side bearing guides 607 that are fixed and attached to the surface of the first carrying-in guide plate 211 that becomes opposite to a surface that forms the carrying-in path Ra in correspondence with the two driving-side bearings 606, respectively, and support the reversal driving roll 400a so as to be movable to the side close to the carrying-in path Ra and the side away from the carrying-in path Ra via the driving-side bearings 606. Moreover, the advancing and retreating mechanism 600 includes driven-side bearings 611 that are respectively attached to both ends of the shaft 4001b of the reversal driven roll 400b in the upstream first reversal roll pair 401, and rotatably support the reversal driven roll 400b, driven-side bearing guides 612 that are fixed and attached to the surface of the second carrying-in guide plate 212 that becomes opposite to a surface that forms the carrying-in path Ra in correspondence with the two driven-side bearings 611, respectively, and support the reversal driven roll 400b so as to be movable to the side close to the carrying-in path Ra and the side away from the carrying-in path Ra, and springs 613 that have both ends fixed and attached to the surface of the second carrying-in guide plate 212 that becomes opposite to a surface that forms the carrying-in path Ra, and have a middle portion arranged to come into contact with portions outside the portions of the driven-side bearings 611 that are supported by the driven-side bearing guides 612.

In contrast, the rotating mechanism 700 of the present exemplary embodiment includes a rotational motor 701 for rotating the reversal driving roll 400a in the upstream first reversal roll pair 401, a motor-side pulley 702 that is attached to a rotating shaft of the rotational motor 701, a roll-side pulley 703 that is fixed and attached to one end of the shaft 4001a in the reversal driving roll 400a, and a timing belt 704 that has an endless shape and is stretched over the motor-side pulley 702 and the roll-side pulley 703.

First, the operation (hereinafter referred to as a contact operation) shifting the upstream first reversal roll pair 401 in a separation state to a contact state will be described. In addition, in an initial state in the contact operation, the motor 601 for advance and retreat stops its driving, the upstream first reversal roll pair 401 and the advancing and retreating mechanism 600 are put in the positional relationship shown in FIGS. 12B and 12C, and the rotating mechanism 700 is put in the state shown by a solid line in FIG. 12D. Additionally, in the initial state in the contact operation, the rotational motor 701 stops its driving, and both the reversal driving roll 400a and the reversal driven roll 400b that constitute the upstream first reversal roll pair 401 stop their rotation. At this time, each resin roll 4002b provided at the reversal driven roll 400b advances to the carrying-in path Ra and is put at a position where the resin roll does not block the carrying-in path Ra, and each rubber roll 4002a provided at the reversal driving roll 400a is put at a position where the rubber roll has withdrawn from the carrying-in path Ra.

The rotational motor 701 starts its rotation with the start of the contact operation. Then, the reversal driving roll 400a of the upstream first reversal roll pair 401 starts its rotation via the motor-side pulley 702, the timing belt 704, and the roll-side pulley 703 with the rotation of the rotational motor 701. In addition, since the reversal driving roll 400a and the reversal driven roll 400b are in non-contact at this time, the reversal driven roll 400b remains in a state in which its rotation is stopped.

Next, the motor 601 for advance and retreat starts its rotation. Then, each driving-side cam 604 starts its rotation with the rotation of the motor 601 for advance and retreat via the gear train 602 and the shaft 603 for a driving-side cam. The motor 601 for advance and retreat stops its rotation when each driving-side cam 604 half-rotates from the state shown in FIG. 12B and is brought into a state shown in FIG. 12A. With such rotation of each driving-side cam 604, each ball bearing 605 is pushed up to the side closer to the carrying-in path Ra by the cam surface of each driving-side cam 604. As a result, the reversal driving roll 400a including the shaft 4001a to which each driving-side cam 604 is attached approaches the reversal driven roll 400b that faces the reversal driving roll across the carrying-in path Ra, and advances into the carrying-in path Ra. Thereafter, in the carrying-in path Ra, each rubber roll 4002a provided at the reversal driving roll 400a and each resin roll 4002b provided at the reversal driven roll 400b come into contact with each other. In addition, when a sheet P exists in the carrying-in path Ra at this time, the reversal driving roll 400a and the reversal driven roll 400b come into contact with each other via the sheet P.

As the reversal driving roll 400a comes into contact with the reversal driven roll 400b, the reversal driven roll 400b receives a force directed to the side away from the carrying-in path Ra, from the reversal driving roll 400a. As a result, the reversal driven roll 400b tends to move to the side away from the carrying-in path Ra. Here, in the present exemplary embodiment, the driven-side bearings 611 attached to both ends of the shaft 4001b of the reversal driven roll 400b receive a force directed to the side closer to the carrying-in path Ra, via the springs 613 attached to the second carrying-in guide plate 212. For this reason, while maintaining a state where the reversal driven roll 400b is supported on the second carrying-in guide plate 212 by each driven-side bearing 611 and each driven-side bearing guide 612, the reversal driven roll comes to rest at a position where a force using the reversal driving roll 400a and a force using the spring 613 are balanced.

In contrast, as the reversal driving roll 400a comes into contact with the reversal driven roll 400b, the reversal driven roll 400b starts its rotation under the driving force from the reversal driving roll 400a. At this time, the contact position between the reversal driving roll 400a and the reversal driven roll 400b is inside the carrying-in path Ra. In addition, when a shift to a contact state from a separation state is made, the roll-side pulley 703 moves from a position shown by a solid line in FIG. 12D to a position shown by a broken line in the drawing with respect to the rotational motor 701 and the motor-side pulley 702. At this time, the position variation between the motor-side pulley 702 attached to the rotational motor 701, and the roll-side pulley 703 attached to the reversal driving roll 400a side is absorbed by a timing belt 704, and the rotation of the reversal driving roll 400a is continued irrespectively of the position variation.

Subsequently, the operation (hereinafter referred to as a separation operation) shifting the upstream first reversal roll pair 401 in a contact state to a separation state will be described. In addition, in an initial state in the separation operation, the motor 601 for advance and retreat stops its driving, the upstream first reversal roll pair 401 and the advancing and retreating mechanism 600 are put in the positional relationship shown in FIG. 12A, and the rotating mechanism 700 is put in the state shown by a broken line in FIG. 12D. Additionally, in the initial state in the separation operation, the rotational motor 701 stops its driving, and both the reversal driving roll 400a and the reversal driven roll 400b that constitute the upstream first reversal roll pair 401 continue their rotation. At this time, each rubber roll 4002a provided at the reversal driving roll 400a and each resin roll 4002b provided at the reversal driven roll 400b are put at a position where the rubber roll and the resin roll have advanced to the carrying-in path Ra.

The rotational motor 701 stops its rotation with the start of the separation operation. Then, as the rotational motor 701 stops its rotation, the reversal driving roll 400a stops its rotation along with the motor-side pulley 702, the timing belt 704, and the roll-side pulley 703. Additionally, as the reversal driving roll 400a stops its rotation, the reversal driven roll 400b in contact with the reversal driving roll 400a also stops its rotation. In addition, when a sheet P is present in the carrying-in path Ra at this time, the transport of the sheet P pinched by the reversal driving roll 400a and the reversal driven roll 400b is also stopped.

Subsequently, the motor 601 for advance and retreat starts its rotation. Then, each driving-side cam 604 starts its rotation with the rotation of the motor 601 for advance and retreat via the gear train 602 and the shaft 603 for a driving-side cam. The motor 601 for advance and retreat stops its rotation when each driving-side cam 604 half-rotates from the state shown in FIG. 12A and is brought into the state shown in FIG. 12E. With such rotation of each driving-side cam 604, each ball bearing 605 is pushed down to the side away from the carrying-in path Ra by the cam surface of each driving-side cam 604. As a result, the reversal driving roll 400a including the shaft 4001a to which each driving-side cam 604 is attached keeps away from the reversal driven roll 400b that faces and contacts the reversal driving roll across the carrying-in path Ra. Then, in the carrying-in path Ra, each rubber roll 4002a provided at the reversal driving roll 400a separates from each resin roll 4002b provided at the reversal driven roll 400b, and withdraws from the carrying-in path Ra.

As the reversal driving roll 400a separates from the reversal driven roll 400b, the reversal driven roll 400b does not receive a force directed to the side away from the carrying-in path Ra, from the reversal driving roll 400a, while the reversal driven roll receives a force directed to the side close to the carrying-in path Ra via the springs 613 and the driven-side bearing guides 612. As a result, the reversal driven roll 400b tends to move to the side close to the carrying-in path Ra. Here, in the present exemplary embodiment, the movement directed to the carrying-in path Ra side of the driven-side bearings 611 attached to both ends of the shaft 4001b of the reversal driven roll 400b is regulated by the driven-side bearing guides 612 provided corresponding to the driven-side bearings, respectively. For this reason, while maintaining a state where the reversal driven roll 400b is supported on the second carrying-in guide plate 212 by each driven-side bearing 611 and each driven-side bearing guide 612, the reversal driven roll comes to rest at a position where the reversal driven roll is butted against the end of each driven-side bearing guide 612 at the carrying-in path Ra side by a pressing force by the spring 613. At this time, each resin roll 4002b provided at the reversal driven roll 400b is put at a position where the resin roll does not block the carrying-in path Ra while maintaining the state of having advanced to the carrying-in path Ra.

In addition, although the upstream first reversal roll pair 401 has been described here as an example, the upstream second reversal roll pair 402 to the upstream fourth reversal roll pair 404 that constitute the upstream reversal transport part 400A along with the upstream first reversal roll pair 401 are also provided with the advancing and retreating mechanism 600 and the rotating mechanism 700. Additionally, the first carrying-in roll pair 301 to the sixth carrying-in roll pair 306 that constitute the carrying-in transport part 300, the downstream first reversal roll pair 421 to the downstream fourth reversal roll pair 424 that constitute the downstream reversal transport part 400C, and the first carrying-out roll pair 501 to the sixth carrying-out roll pair 506 that constitute the carrying-out transport part 500 are also provided with the advancing and retreating mechanism 600 and the rotating mechanism 700. In contrast, although the midstream first reversal roll pair 411 to the midstream third reversal roll pair 413 that constitute the midstream reversal transport part 400B are provided the rotating mechanism 700 for rotating these roll pairs, the advancing and retreating mechanism 600 for advancing and retreating these roll pairs is not provided.

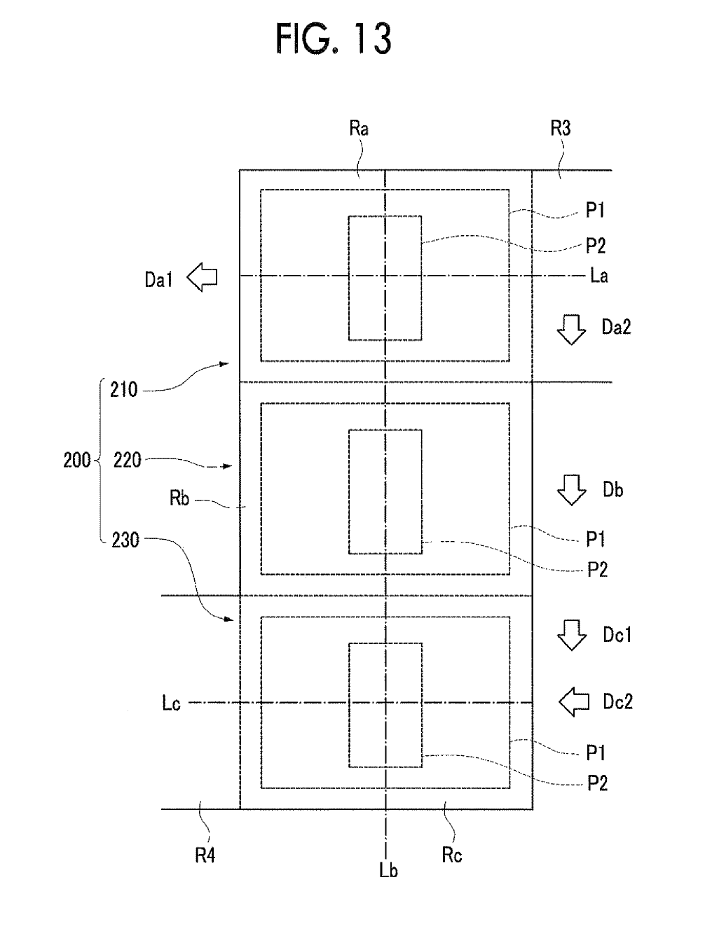

Next, the reversal transport operation of a sheet P using the first reversal device 100 of the present exemplary embodiment will be described. Here, FIG. 13 is a view illustrating the behavior of the sheet P that passes through the first reversal device 100. In addition, FIG. 13 illustrates a first sheet P1 and a second sheet P2 that are different in size as the sheet P. FIG. 13 shows a case where the first sheet P1 is a JISA3 size longitudinal feed (SEF: Short End Feed), and a case where the second sheet P2 is JISA4 size traverse feed (LEF: Long End Feed), respectively.

In addition, in the initial state, the first carrying-in roll pair 301 to the sixth carrying-in roll pair 306 that constitute the carrying-in transport part 300 are set to a separation state and a rotation stop state. Additionally, the upstream first reversal roll pair 401 to the upstream fourth reversal roll pair 404 that constitute the upstream reversal transport part 400A are set to a separation state and a rotation stop state. Moreover, the midstream first reversal roll pair 411 to the midstream third reversal roll pair 413 that constitute the midstream reversal transport part 400B are set to a state in which the rotation is stopped. Furthermore, the downstream first reversal roll pair 421 to the downstream fourth reversal roll pair 424 that constitute the downstream reversal transport part 400C are set to a separation state and a rotation stop state. The first carrying-out roll pair 501 to the sixth carrying-out roll pair 506 that constitute the carrying-out transport part 500 are set to a separation state and a rotation stop state.

For example, when image are formed on both surfaces of a sheet P, the sheet P that is transported within the first transporting path R1, and has an image formed on one surface by the respective image forming units 10, the secondary transfer device 30, and the fixing device 50 is transported to the third transporting path R3 via the second transporting path R2. In the third transporting path R3, the sheet P is transported, with the sheet leading edge P1 as a lead and the other surface turned up. This other side becomes the sheet front surface Pf. At this time, the control unit 80 makes a sheet P transported such that the middle position of the sheet width in the sheet P overlaps with the carrying-in direction transport reference line La, based on the length (hereinafter referred to as sheet width) the sheet P from the sheet first lateral edge Ps1 to the sheet second lateral edge Ps2, which is input by the UI 90 or the like.

Next, in the third transporting path R3, the control unit 80 starts the rotation operation and contact operation of the carrying-in transport part 300, based on the results when the passage of the sheet leading edge P1 of the sheet P is detected by the sheet detection sensor 60. Therefore, in the carrying-in path Ra, the carrying-in transport part 300 is set to a contact state, and starts its rotation.

Subsequently, the sheet P moves along the carrying-in direction Da1 into the carrying-in path Ra from the inside of the third transporting path R3. At this time, in the carrying-in path Ra, the carrying-in transport part 300 is set to a contact state and is rotating. In contrast, at this time, in the carrying-in path Ra, the upstream reversal transport part 400A is set to a separation state and stops its rotation. Accordingly, the sheet P advanced into the carrying-in path Ra from the third transporting path R3 moves along the carrying-in direction Da1, with the sheet leading edge P1 as a lead and the sheet front surface Pf turned up, while being pinched by the carrying-in transport part 300. Here, in the present exemplary embodiment, each reversal driven roll 400b in the upstream reversal transport part 400A set to a separation state remains advanced to the carrying-in path Ra (refer to FIG. 11B). However, since the resin roll 4002b provided at each reversal driven roll 400b has a tapered shape (refer to FIG. 10B), each reversal driven roll 400b does not easily become a hindrance when a sheet P is transported along the carrying-in direction Da1.

Then, the sheet P stops within the carrying-in path Ra. At this time, the control unit 80 stops the rotation operation of the carrying-in transport part 300 and further starts the separation operation of the carrying-in transport part 300 at a timing when the middle position of the sheet length in the sheet P reaches the reversal direction transport reference line Lb, based on the lapsed time after the passage of the sheet leading edge P1 of the sheet P is detected by the sheet detection sensor 60, and the length (hereinafter referred to as sheet length) of the sheet P from the sheet leading edge P1 to the sheet trailing edge Pt, which is input by the UI 90 or the like. Accordingly, the respective carrying-in driving rolls 300a that constitute the carrying-in transport part 300 in addition to the respective reversal driving rolls 400a that constitute the upstream reversal transport part 400A also no longer come into contact with the sheet P in the carrying-in path Ra. As a result, the sheet P in the carrying-in path Ra stops in a state where the sheet first lateral edge Ps1 faces the reversal path Rb and the sheet front surface Pf is turned up. At this time, the sheet P that stops within the carrying-in path Ra is brought into a state where the middle position of the sheet width overlaps the carrying-in direction transport reference line La and the middle position of the sheet length overlaps the reversal direction transport reference line Lb, irrespective of the size and orientation thereof.

Next, the sheet P moves along the transfer direction Da2 within the carrying-in path Ra. At this time, the control unit 80 stops the sheet P within the carrying-in path Ra, and then starts the rotation operation and contact operation of the upstream reversal transport part 400A. Therefore, in the carrying-in path Ra, the upstream reversal transport part 400A is set to a contact state, and starts its rotation. In contrast, at this time, in the carrying-in path Ra, the carrying-in transport part 300 is set to a separation state and stops its rotation. Accordingly, the sheet P stopped within the carrying-in path Ra moves along the transfer direction Da2, with the sheet first lateral edge Ps1 as a lead and the sheet front surface Pf turned up, while being pinched by the upstream reversal transport part 400A. In the present exemplary embodiment, each carrying-in driven roll 300b in the carrying-in transport part 300 set to a separation state remains advanced to the carrying-in path Ra (refer to FIG. 11A). However, since the resin roll 3002b provided at each carrying-in driven roll 300b has a tapered shape (refer to FIG. 10A), and each carrying-in driven roll 300b does not easily become a hindrance when a sheet P is transported along the transfer direction Da1.

In addition, in this example, the control unit 80 starts the rotation operation of the midstream reversal transport part 4005 and the rotation operation and contact operation of the downstream reversal transport part 400C, in cooperation with starting the rotation operation and contact operation of the upstream reversal transport part 400A. Therefore, the midstream reversal transport part 400B starts its rotation in the reversal path Rb. Additionally, therefore, in the carrying-out path Rc, the downstream reversal transport part 400C is set to a contact state, and starts its rotation.

Subsequently, the sheet P moves into the reversal path Rb from the inside of the carrying-in path Ra, and further moves to the carrying-out path Rc from the reversal path Rb along the transfer direction Da2, the reversal direction Db, and receiving direction Dc1. At this time, in the carrying-in path Ra, the upstream reversal transport part 400A is set to a contact state and is rotating. Additionally, at this time, the midstream reversal transport part 400B is rotating in the reversal path Rb. Moreover, at this time, in the carrying-out path Rc, the downstream reversal transport part 400C is set to a contact state and is rotating. In contrast, at this time, in the carrying-out path Rc, the carrying-out transport part 500 is set to a separation state and stops its rotation. Accordingly, the sheet P advanced into the reversal path Rb from the carrying-in path Ra moves such that the leading edge thereof runs along the reversal direction Db and the trailing edge thereof runs along the transfer direction Da2, with the sheet first lateral edge Ps1 as a lead and the sheet front surface Pf turned up, while being pinched between the upstream reversal transport part 400A and the midstream reversal transport part 400B. Then, the sheet P advanced into the reversal path Rb moves along the reversal direction Db, shifting from a state where the sheet first lateral edge Ps1 becomes a lead and the sheet front surface Pf is turned up to a state where the sheet back surface Pb is turned up, while being pinched by the midstream reversal transport part 400B. Thereafter, the sheet P advanced into the carrying-out path Rc from the reversal path Rb moves such that the leading edge thereof runs along the receiving direction Dc1 and the trailing edge thereof runs along the reversal direction Db, with the sheet first lateral edge Ps1 as a lead and the sheet back surface Pb turned up, while being pinched by the downstream reversal transport part 400C and the midstream reversal transport part 400B. While the sheet reaches the carrying-out path Rc via the reversal path Rb from the carrying-in path Ra, the sheet P is transported such that the middle position of the sheet length thereof overlaps the reversal direction transport reference line Lb. In the present exemplary embodiment, each carrying-out driven roll 500b in the carrying-out transport part 500 set to a separation state remains advanced to the carrying-out path Rc (refer to FIG. 11E). However, since the resin roll 5002b provided at each carrying-out driven roll 500b has a tapered shape (refer to FIG. 10E) and each carrying-out driven roll 500b does not easily become a hindrance when a sheet P is transported along the receiving direction Dc1.

Then, the sheet P stops within the carrying-out path Rc. At this time, the control unit 80 stops the rotation operation of the downstream reversal transport part 400C, and further starts the separation operation of the downstream reversal transport part 400C, at a timing when the middle position of the sheet width in the sheet P reaches the carrying-out direction transport reference line Lc, for example, based on the lapsed time after the transport of the sheet P using the upstream reversal transport part 400A is started. Therefore, the respective reversal driving rolls 400a that constitute the downstream reversal transport part 400C in addition to the respective carrying-out driving rolls 500a that constitute the carrying-out transport part 500 also no longer come into contact with the sheet P within the carrying-out path Rc. As a result, the sheet P within the carrying-out path Rc stops in a state where the sheet leading edge P1 faces the fourth transporting path R4 and the sheet back surface Pb is turned up. At this time, the sheet P within the carrying-out path Rc is brought into a state where the middle position of the sheet length overlaps the reversal direction transport reference line Lb and the middle position of the sheet width overlaps the carrying-out direction transport reference line Lc, irrespective of the size and direction thereof.

Here, in the present exemplary embodiment, the distance from the carrying-in direction transport reference line La in the carrying-in path Ra via the reversal path Rb to the carrying-out direction transport reference line Lc in the carrying-out path Rc is determined regardless of the size of the sheet P to be transported. Accordingly, the period in which a sheet P is transported to the carrying-out path Rc via the reversal path Rb from carrying-in path Ra becomes constant irrespective of the size of the sheet P when the transport speed of a sheet P is constant.

In addition, in this example, the control unit 80 starts the rotation stop operation and separation operation of the upstream reversal transport part 400A and the rotation stop operation of the midstream reversal transport part 400B, in cooperation with starting the rotation stop operation and separation operation of the downstream reversal transport part 400C. Therefore, in the carrying-in path Ra, the upstream reversal transport part 400A is set to a separation state, and stops its rotation, and in the reversal path Rb, the midstream reversal transport part 400B stops its rotation.

Next, the sheet P moves along the carrying-out direction Dc2 within the carrying-out path Rc. At this time, the control unit 80 stops the sheet P within the carrying-out path Rc, and then starts the rotation operation and contact operation of the carrying-out transport part 500. Therefore, in the carrying-out path Rc, the carrying-out transport part 500 is set to a contact state, and starts its rotation. In contrast, at this time, in the carrying-out path Rc, the downstream reversal transport part 400C is set to a separation state and stops its rotation. Accordingly, the sheet P stopped within the carrying-out path Rc moves along the carrying-out direction Dc2, with the sheet leading edge P1 as a lead and the sheet back surface Pb turned up, while being pinched by the carrying-out transport part 500. Then, the sheet P is carried out to the fourth transporting path R4 from the carrying-out path Rc. Here, in the present exemplary embodiment, each reversal driven roll 400b in the downstream reversal transport part 400C set to a separation state remains advanced to the carrying-out path Rc (refer to FIG. 11D). However, since the resin roll 4002b provided at each reversal driven roll 400b has a tapered shape (refer to FIG. 10D), each reversal driven roll 400b does not easily become a hindrance when a sheet P is transported along the carrying-out direction Dc2.

Then, the control unit 80 stops the rotation operation of the carrying-out transport part 500 and further starts the separation operation of the carrying-out transport part 500 at a timing when the sheet P is carried out from the carrying-out path Rc. Therefore, in the carrying-out path Rc, both the downstream reversal transport part 400C and the carrying-out transport part 500 are brought into a separation state.

Thereafter, the sheet P of which the front and back are reversed by the first reversal device 100 is transported again toward the respective image forming units 10 and the fixing device 50 via the first transporting path R1 from the fourth transporting path R4.

In the present exemplary embodiment, the rationale for the respective driving rolls (the carrying-in driving roll 300a, the reversal driving roll 400a, the carrying-out driving roll 500a) from the respective paths in both the carrying-in path Ra and carrying-out path Rc of the first reversal device 100 being withdrawn is based on the following reasons.

First, since the driving rolls receive the rotation from the outside, when a driving roll that is not presented for transport remains in a path, there is a concern that the driving roll that is not prevented for transport may become a hindrance to transport of the sheet P using the other driving rolls which are presented for transport. Additionally, in the present exemplary embodiment, each driving roll has rubber rolls having a coefficient of friction higher than the resin rolls that constitutes each driven roll. Thus, when a driving roll which is not presented for transport remains in a path, there is concern that the driving roll that is not presented for transport becomes a hindrance to transport of the sheet P using the other driving rolls which are presented for transport. Thus, in the present exemplary embodiment, in each path, a configuration in which each driven roll including the resin rolls is left in each path and each driving roll offering the rubber rolls is withdrawn from each path is adopted.

Next, the second reversal device 110 will be described in detail.

The second reversal device 110 has a reversal path H1 that extends in a direction that intersects the second transporting path R2, an introduction path D1 along which a sheet P is introduced from the second transporting path R2 to the reversal path H1, and a lead-out path D2 along which a sheet P is led out from the reversal path H1 to the second transporting path R2. The reversal path H1 is formed so as to be continuous with the third transporting path R3. The second reversal device 110 includes rotatable plural (two in this example) feed rolls 111 for reversal in both directions on the reversal path H1. The feed rolls 111 for reversal rotate in one rotational direction when sheet is introduced from the second transporting path R2 to the reversal path H1 via the introduction path D1 so as to reverse the sheet P, and rotates in the other rotational direction when a sheet P is led out from the reversal path H1 to the second transporting path R2 via the lead-out path D2.

The second reversal device 110 includes a first gate 112 that switches whether the sheet P transported from the fixing device 50 side is passed through the second transporting path R2 as it is or the sheet is guided to the reversal path H1 via the introduction path D1, at a connection portion of the introduction path D1 to the second transporting path R2. Additionally, the second reversal device 110 includes a second gate 113 that switches whether the sheet P passed through the introduction path D1 is guided to the reversal path H1 or whether the sheet is guided from the reversal path H1 via the lead-out path D2 to the second transporting path R2, at a connection portion between the introduction path D1 and the lead-out path D2.

In the second reversal device 110 configured in this way, the control unit 80 controls the driving of the feed rolls 111 for reversal, and the positions of the first gate 112 and the second gate 113, to control the reversing of the front and back of a sheet P such that the leading edge and trailing edge of the sheet in the sheet transporting direction are switched, and the passage of the second transporting path R2.

Next, a configuration surrounding the butting member 43 will be described.

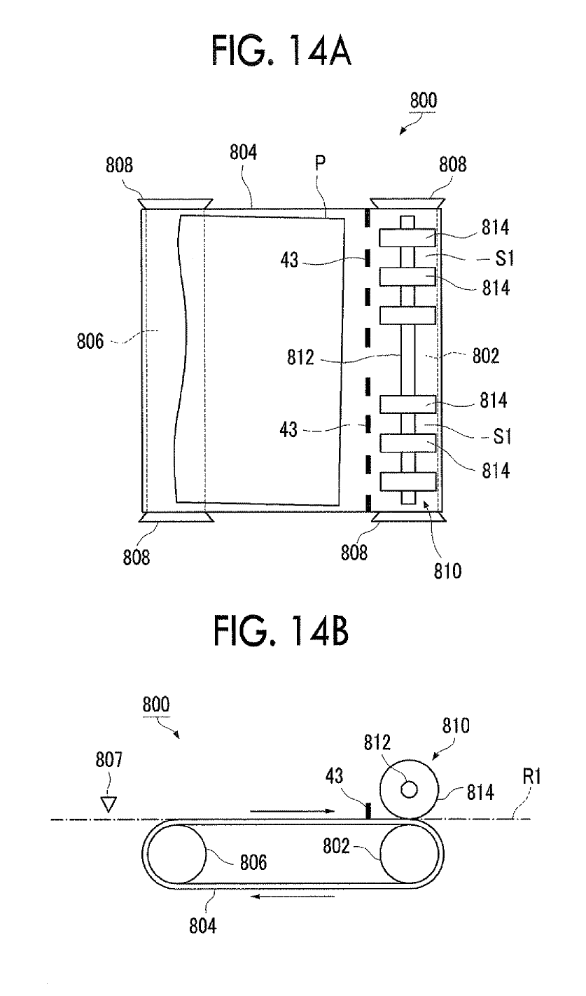

FIG. 14 is a view illustrating a configuration around the butting member 43 shown in FIG. 1. In addition, FIG. 14A is a view when the case seen in FIG. 1 is seen from above, and FIG. 14B is a view when the case seen in FIG. 1 is seen from the near side.

Although the image forming apparatus 1 related to the present exemplary embodiment is omitted in FIG. 1, the image forming apparatus includes a moving mechanism 800 that moves the butting member 43 along the transporting direction of a sheet P (along the first transporting path R1), between the second feed roll 45 and the third feed roll 46.

The moving mechanism 800 includes a driving roll 802 that is rotationally driven by a motor (not shown), an endless belt 804 that moves in a circulating manner under a driving force from the driving roll 802, and a supporting roll 806 that is provided closer to the upstream side in the transporting direction of a sheet P than the driving roll 802 to impart tension to the belt 804 and to support the belt 804 from the inside. In addition, in the present exemplary embodiment, the driving roll 802 is provided closer to the downstream side in the transporting direction of a sheet P than the supporting roll 806. In this case, tension is imparted to the portion of the belt 804 located on the first transporting path R1 side so as to keep loosening or the like from occurring in the portion of the belt 804 that comes into contact with the sheet P. Additionally, the moving mechanism 800 includes a sensor 807 for skew that detects the leading edge of a sheet P, on the downstream side of the third feed roll 46 in the transporting direction and on the upstream side of the supporting roll 806 in the transporting direction.

Flange portions 808 that regulate the movement of the belt 804 in the width direction (direction orthogonal to the transporting direction of a sheet P) of the belt 804 are respectively provided at both ends of the driving roll 802 and at both ends of the supporting roll 806. In addition, illustration of the flange portions 808 is omitted in FIG. 14B. Additionally, in the present exemplary embodiment, the butting member 43 is provided so as to be fixed to the outer peripheral surface of the belt 804 and protrudes from the outer peripheral surface. Moreover, plural butting members 43 are provided as shown in FIG. 14A, and are arranged in an aligned state at predetermined intervals in the direction (width direction of a belt 804) orthogonal to the transporting direction of a sheet P.

The moving mechanism 800 includes a rotating roll 810 that is pressed against the driving roll 802 via the belt 804 and rotates under a driving force from the belt 804. The rotating roll 810 is formed by a rotating shaft 812 provided along the direction orthogonal to the transporting direction of a sheet P, and a cylindrical contacting member 814 that is rotated by the rotating shaft 812 and has an outer peripheral surface contacting the sheet P. As shown in FIG. 14A, plural contacting members 814 are provided. Additionally, the respective contacting members 814 are arranged at mutually differing positions in the direction orthogonal to the transporting direction of a sheet P, and are provided in an aligned state in the direction orthogonal to the transporting direction of the sheet P. Additionally, in the present exemplary embodiment, a gap S1 is formed between mutually adjacent contacting members 814.

Here, the butting member 43 is moved toward the downstream side in the transporting direction of a sheet P by the moving mechanism 800. Additionally, in the present exemplary embodiment, the traveling speed of the belt 804 and the transport speed of a sheet P using the third feed roll 46 (refer to FIG. 1) are set such that the transport speed of the sheet P using the third feed roll 46 (refer to FIG. 11) becomes greater than the traveling speed (peripheral speed) of the belt 804. For this reason, if a sheet P is transported by the third feed roll 46, the sheet P gradually approaches the butting member 43, and then, the leading edge of the sheet P butts against the butting member 43. Thereby, the skew of the sheet P is corrected.

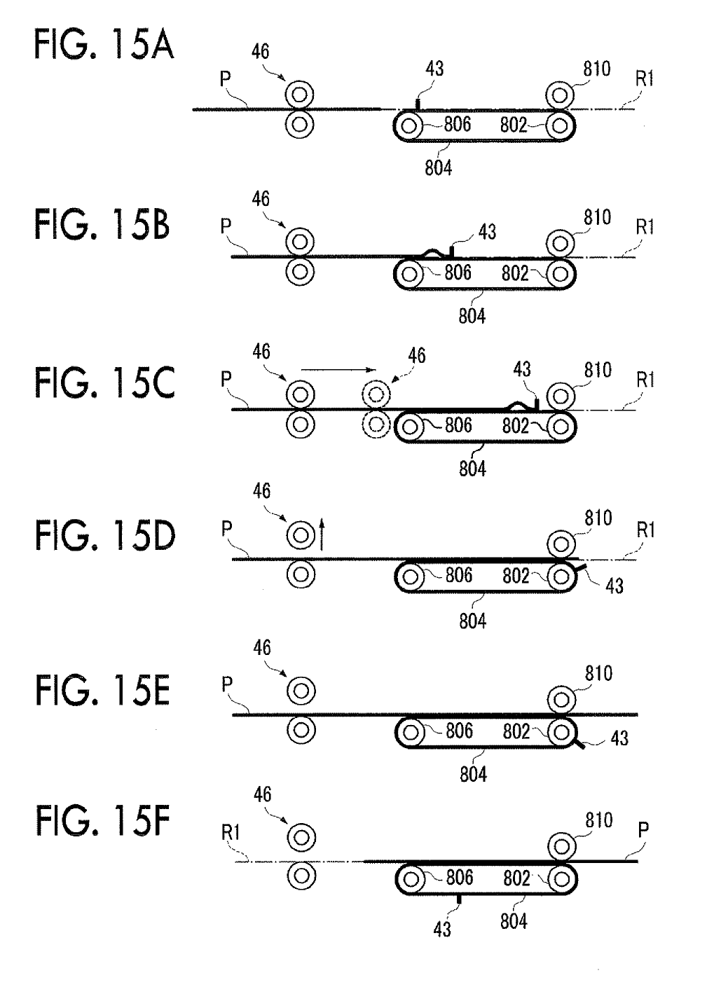

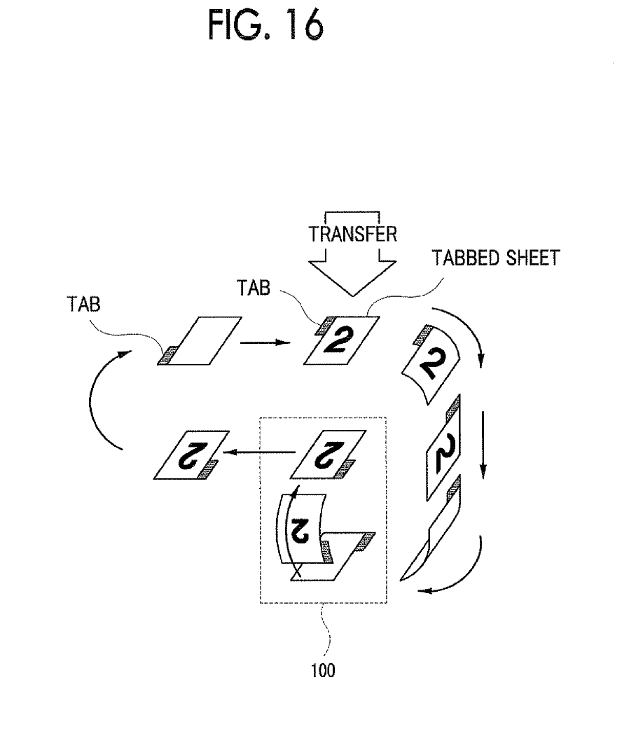

FIGS. 15A to 15F are views showing the actions of the butting member 43 and the moving mechanism 800.

In the image forming apparatus 1 related to the present exemplary embodiment, as shown in FIG. 15A, first, a sheet P is transported from the upstream side by the third feed roll 46. Next, as the leading edge of the sheet P is detected by the sensor 807 for skew, the rotational driving of the driving roll 802 is started, and the movement of the butting member 43 is started. Thereafter, as shown in FIGS. 15B and 15C, the leading edge of the sheet P butts against the butting member 43, and the transport of the sheet P continues in this state. Thereby, the leading edge of the sheet P runs along the direction orthogonal to the transporting direction of the sheet P, and the skew of the sheet P is corrected.

Thereafter, as shown in FIG. 15D, the butting member 43 reaches a location that exceeds the rotating roll 810, the sheet P is held (nipped) by the rotating roll 810 and the belt 804, and the transport of the sheet P by the rotating roll 810 and the belt 804 is started. Additionally, after the transport of the sheet P by the rotating roll 810 and the belt 804 is started, as shown in FIG. 15D, the butting member 43 withdraws from the first transporting path R1 and the butting member 43 separates from the leading edge of the sheet P. In the present exemplary embodiment, the leading edge of the sheet P is pressed against the butting members 43 until the sheet P is held (nipped) by the rotating roll 810 and the belt 804.

In addition, in the present exemplary embodiment, after the sheet P is held by the rotating roll 810 and the belt 804, as shown in FIG. 15D, one roll-shaped member of a pair of roll-shaped members that constitute the third feed roll 46 is separated from the other roll-shaped member. In addition, whether or not the sheet P is held by the rotating roll 810 and the belt 804 is determined by detecting the leading edge point of the sheet P using a sensor (not shown) provided on the downstream side of the rotating roll 810.

Thereafter, in the present exemplary embodiment, as shown in FIGS. 15E and 15F, the sheet P is further transported to the downstream side and is further transported to the downstream side by the second feed roll 45 (refer to FIG. 1) and the first feed roll 44. In addition, in the present exemplary embodiment, after the sheet P is held (nipped) by the first feed roll 44, the roll-shaped member in the second feed roll 45 is separated from the other roll-shaped member, and the rotating roll 810 is separated from the belt 804. Here, the image forming apparatus 1 related to the present exemplary embodiment has a sensor that detects the lateral edge of the sheet P, and moves the first feed roll 44 that nips the sheet P in the direction orthogonal to the transporting direction of the sheet P, based on the detected result using this sensor.

Thereby, the sheet P passes through a given position in the direction orthogonal to the transporting direction of the sheet P, and an image is formed on an intended location on the sheet P.

Additionally, when a sheet P is sent into a secondary transfer section, which is constituted by the secondary transfer roll 31 and the roll member 23, using the first feed roll 44, the arrival timing of a sheet P for transfer processing is adjusted by a timing adjustment mechanism (not shown). This timing adjustment mechanism makes the transport speed of the sheet P by the first feed roll 44 variable so as to adjust the arrival timing of the sheet P to the secondary transfer section at the arrival timing of a toner image to the secondary transfer section, based on the timing when a registration sensor 32 (refer to FIG. 1) provided on the upstream side in the sheet transporting direction of the first feed roll 44 has detected the passage of the leading edge of a sheet P.

Next, an aspect in which the control unit 80 in the image forming apparatus 1 configured as described above controls the operation of the respective devices and respective sections that constitute the image forming apparatus 1 will be described.

FIG. 16 is a view showing the operation when there is a request for image formation on both surfaces of a tabbed sheet.

In the image forming apparatus 1 configured as described above, the control unit 80 controls the respective sections as follows when there is a request from a user for image formation on both surfaces of special sheet having a special part so that at least a portion of an edge of sheet is not straight. In addition, the special sheet may include, for example, tabbed sheet that has a tab, which protrudes outward from at least one edge of four edges, at this edge, unlike a rectangular plain sheet in which all four edges are straight. The tabbed sheet will be described below as an example.

When there is a request from a user for image formation on both surfaces of the tabbed sheet, the control unit 80 drives the take-out roll 42 of the first sheet supply device 40A or the second sheet supply device 40B that has the sheet storing section 41 in which a tabbed sheet is stored, in order to take out the tabbed sheet from the sheet storing section 41 in which the tabbed sheet is stored, and supplies the tabbed sheet to the first transporting path R1. As described above, since the tabbed sheet is stored in the sheet storing section 41 so as to be taken out by the take-out roll 42 from an edge opposed to an edge having a tab, the tabbed sheet is transported along the first transporting path R1, with the edge opposed to the edge having the tab as a leading edge of the sheet transporting direction and the edge having the tab as a trailing edge.

Next, if the sensor 807 for skew detects the leading edge of the tabbed sheet transported by the third feed roll 46, the control unit 80 starts the rotational driving of the driving roll 802, and starts the movement of the abutting member 43. Thereby, the leading edge of the tabbed sheet abuts against the abutting member 43, and in this state, the transport of the sheet P is continued and the skew of the tabbed sheet is corrected. Then, the control unit 80 drives the second feed roll 45 and the first feed roll 44, transports the tabbed sheet to the secondary transfer section constituted by the secondary transfer roll 31 and the roll member 23, and transfers a toner image on the intermediate transfer belt 20 to one surface of the tabbed sheet, using the secondary transfer device 30. Then, the control unit 80 fixes the image transferred to one surface of the tabbed sheet onto this tabbed sheet using the fixing device 50.

The control unit 80 switches the positions of the first gate 112 and the second gate 113 to the side where the tabbed sheet is transported to the first reversal device 100, transports the tabbed sheet to the first reversal device 100, and reverses the front and back of the tabbed sheet using the first reversal device 100. As described above, in the first reversal device 100, the front and back of the tabbed sheet are reversed by reversing the relationship between two lateral edges (side edges), without changing the relationship between the leading edge and the trailing edge of the sheet in the sheet transporting direction. Thereafter, the control unit 80 transports the tabbed sheet along the fourth transporting path R4 and the first transporting path R1, using the plural feed rolls 48 provided at the fourth transporting path R4 and the first transporting path R1. In this case, the tabbed sheet is transported, with the edge having the tab as a trailing edge and the edge having no tab that is opposed to the edge having the tab as a leading edge.

Next, if the sensor 807 for skew detects the leading edge of the tabbed sheet transported by the third feed roll 46, the control unit 80 starts the rotational driving of the driving roll 802, and starts the movement of the abutting member 43. Thereby, the leading edge of the tabbed sheet abuts against the abutting member 43, and in this state, the transport of the sheet P is continued and the skew of the tabbed sheet is corrected. Then, the control unit BO drives the second feed roll 45 and the first feed roll 44, transports the tabbed sheet to the secondary transfer section, and transfers a toner image on the intermediate transfer belt 20 to the other surface of the tabbed sheet using the secondary transfer device 30. Then, the control unit 80 fixes the image transferred to the other surface of the tabbed sheet onto this tabbed sheet using the fixing device 50.

As such, since the image forming apparatus 1 related to the present exemplary embodiment includes has the first reversal device 100 that reverses the front and back of sheet, without changing the relationship between the leading edge and trailing edge of sheet in the sheet transporting direction, in both when an image is formed on one surface of two surfaces of the tabbed sheet and when images are formed on the other surface, an edge that is not formed with a tab is allowed to be the leading edge in the sheet transporting direction. Thereby, the edge of the tabbed sheet that is not formed with the tab, that is, an edge that is straight, may be butted against the butting member 43, and compared to a case where the edge formed with the tab, skew correction may be more accurately performed. Additionally, since the registration sensor 32 provided on the upstream side in the sheet transporting direction of the first feed roll 44 detects the edge that is not formed with the tab, that is, the edge that is straight, the arrival timing of the tabbed sheet to the secondary transfer section is more accurately adjusted compared to a case where the edge formed with the tab is detected.

Next, a case where image formation is performed on a bundle of sheets including the tabbed sheet will be described.

The sheet discharged from the opening portion 3 is stacked in a state where the trailing edge of the sheet in the sheet transporting direction abuts against the lateral surface of the housing 2 on the sheet stack section 4 (refer to FIG. 1). Therefore, when image formation is performed on a bundle of sheets composed of a tabbed sheet and a plain sheet, the tabbed sheet is stacked in a state where a tab abuts against the lateral surface of the housing 2 if the tabbed sheet is discharged with the edge formed with the tab as a trailing edge, and is stacked as it is. In contrast, the plain sheet is discharged with a straight edge with no tab as a trailing edge, and is stacked in a state where this edge abuts against the lateral surface of the housing 2. As a result, the plain sheet with no tab and the tabbed sheet are not easily stacked in an orderly manner.

Thus, in the image forming apparatus 1 related to the present exemplary embodiment, the tabbed sheet is discharged and stacked, with the edge that is not formed with the tab as a trailing edge. That is, as described above, when image formation is performed on tabbed sheet, the tabbed sheet is transported, with an edge formed with the tab as a trailing edge and an edge opposed to the edge formed with the tab as a leading edge, to perform secondary transfer and fixation. Thereafter, the tabbed sheet is discharged from the opening portion 3 after the front and back thereof are reversed such that the leading edge and trailing edge of the sheet in the sheet transporting direction are switched by the second reversal device 110.

When a bundle of sheets is stacked on the sheet stack section 4, it is desirable to stack the bundle of sheets in a state where the page numbers of the bundle of sheets are put in order. Therefore, when image formation is performed first in order from sheet with a lower sheet number, and discharge and stacking are then performed, if images are formed on both front and back surfaces of a sheet to be stacked, it is necessary to discharge and stack this sheet from the opening portion 3, with an image with a higher page number of the images to be formed on both surfaces of the sheet turned up.

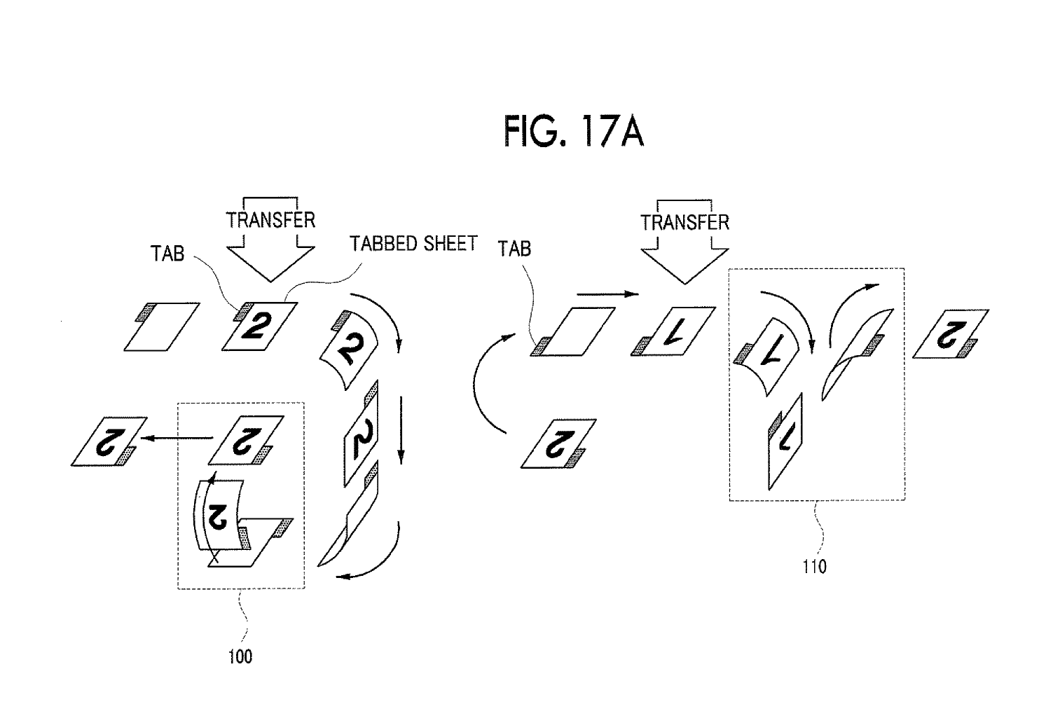

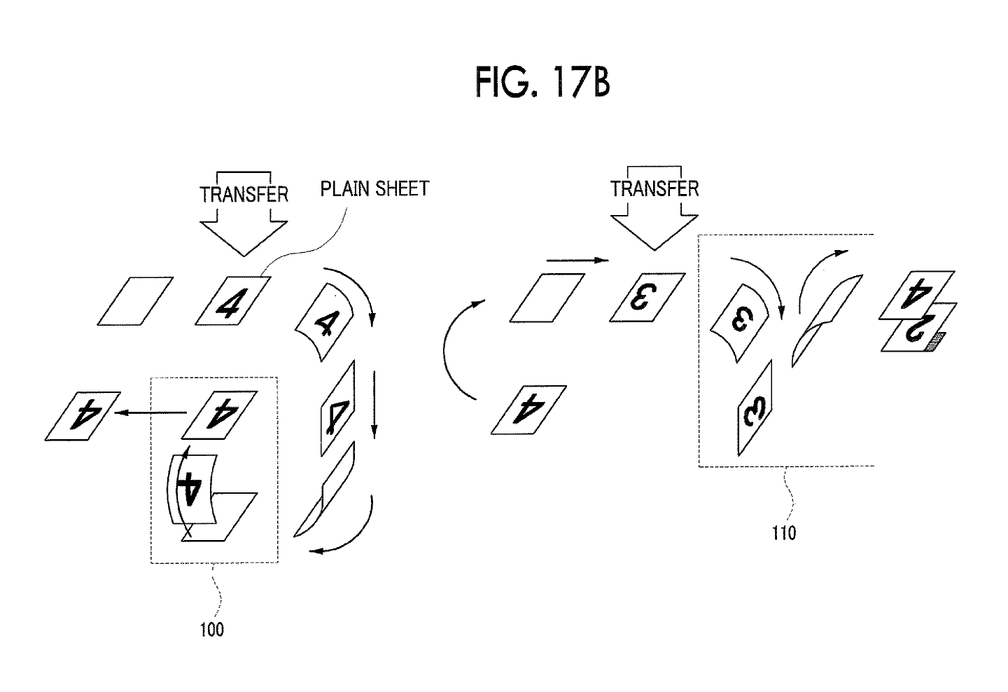

Thus, when there is a request for image formation on a bundle of sheets including a tabbed sheet and a request for image formation on both surfaces of a sheet within the bundle of sheets, the control unit 80 controls the operation of the respective devices and the respective sections that constitute the image forming apparatus 1 as follows. FIGS. 17A and 17B are views showing an operation when there is a request for image formation on a bundle of sheets including a tabbed sheet and a request for image formation on both surfaces of a sheet. FIG. 17A shows an operation when image formation is performed on both surfaces of a tabbed sheet, and FIG. 17B shows an operation when image formation is performed on both surfaces of a plain sheet. In addition, in FIGS. 17A and 17B, an image of a preceding page is numbered as “1” and an image of a following page is numbered as “2”, both of which are to be formed on the tabbed sheet, and an image of a preceding page is numbered as “3” and an image of a following page is numbered as “4”, both of which are to be formed on the plain sheet.

First, a case where image formation is performed on both surfaces of the tabbed sheet within the bundle of sheets will be described. When there is a request for image formation on both surfaces of the tabbed sheet within the bundle of sheets, the control unit 80 drives the take-out roll 42 to transport the tabbed sheet along the first transporting path R1 with an edge formed with a tab as a trailing edge. Then, an image later in the page order, that is, an image of the following page from the images of both surfaces to be formed on this tabbed sheet, is transferred onto on one of two surfaces of the tabbed sheet by the secondary transfer device 30. Then, the image of that subsequent page transferred onto one surface of the tabbed sheet is fixed on this tabbed sheet by the fixing device 50.

Thereafter, the control unit 80 reverses the front and back of the tabbed sheet using the first reversal device 100, and transports the tabbed sheet along the fourth transporting path R4 and the first transporting path R1, using the plural feed rolls 48 provided at the fourth transporting path R4 and the first transporting path R1. Thereafter, an image with a lower page number, that is, an image of a preceding page, from the images of both surfaces to be formed to this tabbed sheet, is transferred onto on the other surface of two surfaces of the tabbed sheet by the secondary transfer device 30. Then, the image of the preceding page transferred onto the other surface of the tabbed sheet is fixed on this tabbed sheet by the fixing device 50.

Then, the control unit 80 reverses the front and back of the tabbed sheet that has the images formed on both surfaces thereof, using the second reversal device 110. That is, the control unit 80 switches the positions of the first gate 112 and the second gate 113 to the side where the tabbed sheet is transported in the direction of the reversal path H1 from the second transporting path R2, rotates the feed rolls 111 for reversal in one rotational direction, and transports the tabbed sheet to the reversal path H1. Then, the control unit 80 switches the position of the second gate 113 to a position where the tabbed sheet is let out from the reversal path H1 to the second transporting path R2 via the lead-out path D2, rotates the feed rolls 111 for reversal in the other rotational direction, discharges the tabbed sheet from the opening portion 3 via the second transporting path R2, and stacks the tabbed sheet on the sheet stack section 4. Since the front and back of the tabbed sheet reversed by the second reversal device 110 are reversed such that the leading edge and trailing edge of the sheet in the sheet transporting direction are switched, the tabbed sheet is transported to the downstream side and discharged from the opening portion 3, with one surface, on which the image of the following page is formed, turned up, and the edge formed with the tab as a leading edge, and is stacked on the sheet stack section 4. Thereby, the tabbed sheet is stacked on the sheet stack section 4 in a state where the edge formed with the tab is located on the right in FIG. 1, an edge opposed to the edge formed with the tab is located on the left, and one surface formed with the image of the following page is turned up.

The processing of the control unit 80 described above will be described using a flowchart.

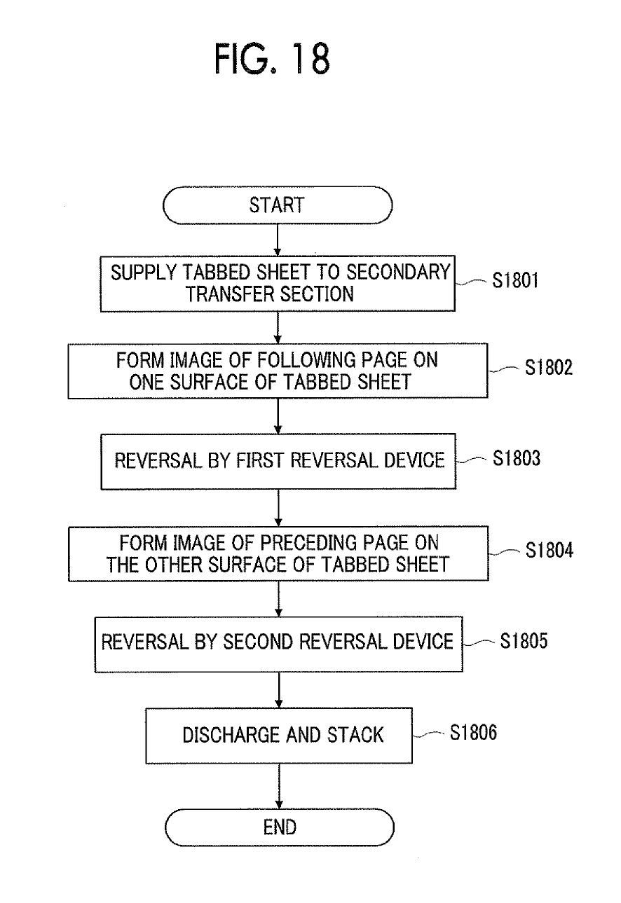

FIG. 18 is a flowchart showing a procedure when the control unit 80 performs image formation on both surfaces of a tabbed sheet within a bundle of sheets including the tabbed sheet.

The control unit 80 supplies the tabbed sheet to the secondary transfer section, with one surface of the two surfaces of the tabbed sheet turned up and the edge formed with the tab as a trailing edge (Step (hereinafter simply referred to as “S”) 1801). Next, an image of the following page is formed on one surface of the tabbed sheet by the secondary transfer device 30 and the fixing device 50 (S1802). Thereafter, the front and back of the tabbed sheet that has the image of the following page formed on one surface thereof are reversed by the first reversal device 100 (S1803). Thereafter, the tabbed sheet is supplied to the secondary transfer section, with the other surface of the two surfaces of the tabbed sheet turned up and the edge formed with the tab as a trailing edge, and an image of a preceding page is formed on the other surface of the tabbed sheet (S1804). Thereafter, the front and back of the tabbed sheet that has the images formed on both surfaces thereof are reversed by the second reversal device 110 (S1805), and is discharged from the opening portion 3, and is stacked on the sheet stack section 4 (S1806).

Next, a case where image formation is performed on both surfaces of a plain sheet within a bundle of sheets will be described.

Even when the sheet within a bundle of sheets on which image formation is performed is plain sheet with no tab, similarly to the tabbed sheet, the control unit 80 first transfers an image of the following page from the images of both surfaces to be formed to this plain sheet, to the plain sheet that is supplied from the first sheet supply device 40A or the second sheet supply device 40B, and reaches the secondary transfer section via the first transporting path R1, using the secondary transfer device 30. Then, the image of the following page transferred is fixed on this plain sheet by the fixing device 50.

Thereafter, the control unit 80 reverses the front and back of the plain sheet using the first reversal device 100, and transports the plain sheet along the fourth transporting path R4 and the first transporting path R1, using the plural feed rolls 48 provided at the fourth transporting path R4 and the first transporting path R1. Thereafter, an image of a preceding page from the images of both surfaces to be formed on this plain sheet is transferred by the secondary transfer device 30. Then, the image of the preceding page transferred is fixed on this plain sheet by the fixing device 50.

Then, the control unit 80 reverses the front and back of the plain sheet that has the images formed on both surfaces thereof using the second reversal device 110, discharges the plain sheet from the opening portion 3 via the second transporting path R2, and stacks the plain sheet on the sheet stack section 4. Since the front and back of the plain sheet reversed by the second reversal device 110 are reversed such that the leading edge and trailing edge of the sheet in the sheet transporting direction are switched, the plain sheet is discharged from the opening portion 3, with one surface, on which the image of the following page is formed, turned up, and is stacked on the sheet stack section 4.

The processing of the control unit 80 described above will be described using a flowchart.

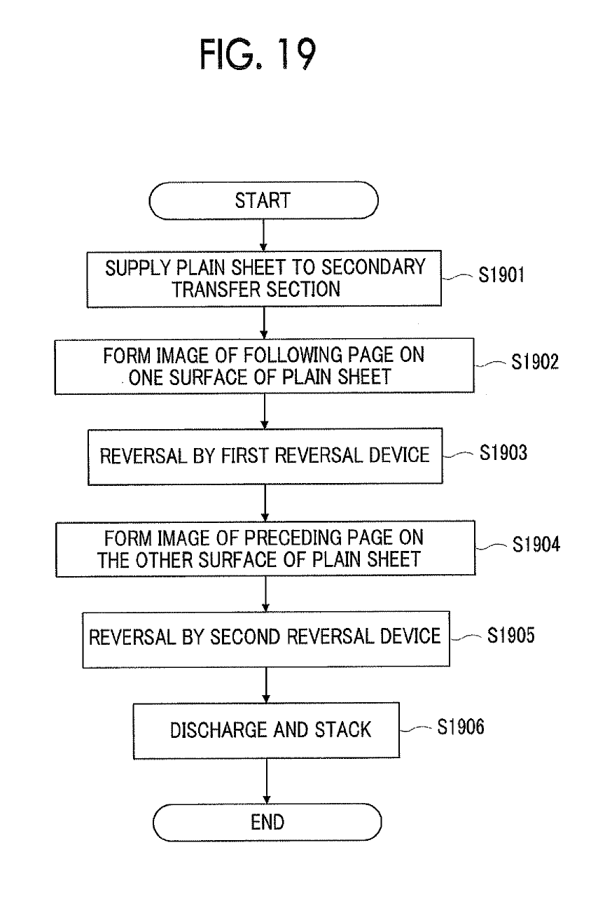

FIG. 19 is a flowchart showing a procedure when the control unit 80 performs image formation on both surfaces of a plain sheet within a bundle of sheets including a tabbed sheet.

The control unit 80 supplies the plain sheet to the secondary transfer section (S1901), and forms an image of a following page on one surface of the plain sheet using the secondary transfer device 30 and the fixing device 50 (S1902). Thereafter, the front and back of the plain sheet that has the image of the following page formed on one surface thereof are reversed by the first reversal device 100 (S1903). Thereafter, the plain sheet is supplied to the secondary transfer section, and an image of a preceding page is formed on the other surface of the plain sheet (S1904). Thereafter, the front and back of the plain sheet that has the images formed on both surfaces thereof are reversed by the second reversal device 110 (S1905), and is discharged from the opening portion 3, and is stacked on the sheet stack section 4 (S1906).

As described above, as the control unit 80 performs image formation on tabbed sheet and plain sheet within a bundle of sheets including the tabbed sheet, both the tabbed sheet and the plain sheet are stacked on the sheet stack section 4, in a state where a surface, on which an image of the following page from the images of both surfaces to be formed on the tabbed sheet or the plain sheet is formed, is turned up. Thus, the plain sheet and the tabbed sheet are stacked in an orderly manner in a state where the sheet numbers of the bundle of sheets are put in order.

In addition, in the above-described example, when image formation is performed on both surfaces of the plain sheet within the bundle of sheets, the aspect in which the front and back of the pain sheet are reversed by the second reversal device 110, and the plain sheet is discharged from the opening portion 3 has been described. However, the invention is not particularly limited to this aspect.

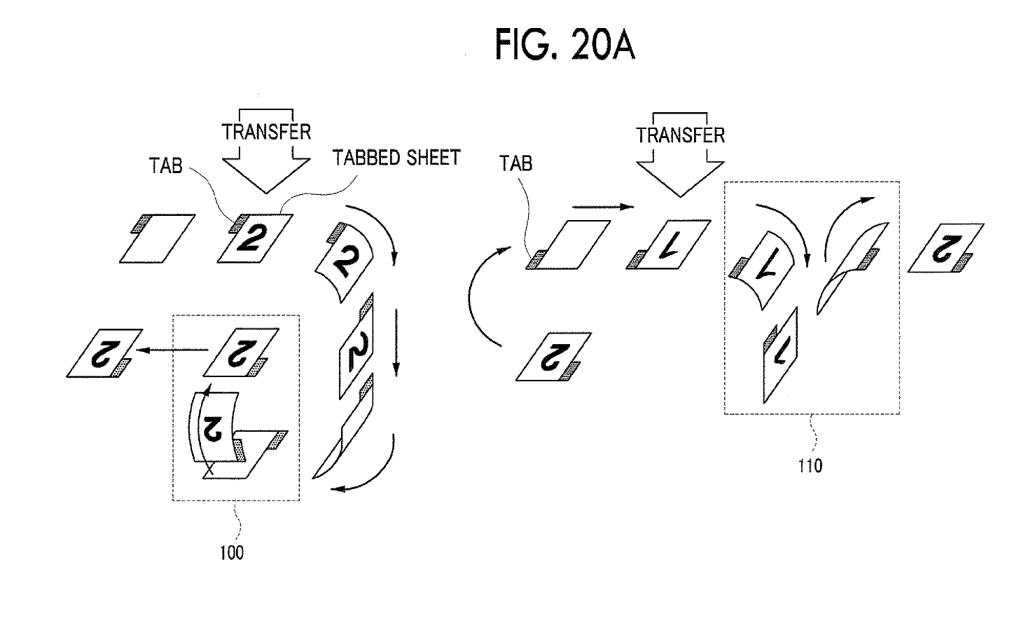

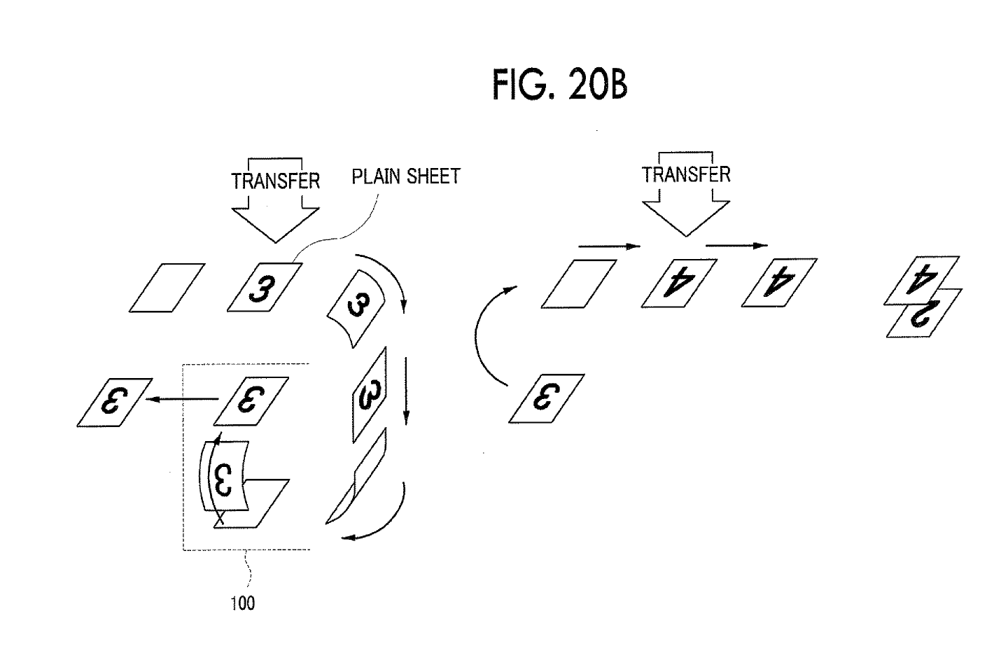

FIGS. 20A and 20B are views showing another operation when there is a request for image formation on a bundle of sheets including a tabbed sheet and a request for image formation on both surfaces of a sheet. FIG. 20A shows an operation when image formation is performed on both surfaces of a tabbed sheet, and FIG. 20B shows an operation when image formation is performed on both surfaces of a plain sheet. In addition, in FIGS. 20A and 20B, an image of a preceding page is numbered as “1” and an image of a following page is numbered as “2”, both of which are to be formed on the tabbed sheet, and an image of a preceding page is numbered as “3” and an image of a following page is numbered as “4”, both of which are to be formed on the plain sheet.

Since the processing of performing image formation on both surfaces of the tabbed sheet within the bundle of sheets is the same as above in the other operation example shown in FIG. 20, the description thereof is omitted. Image formation on both surfaces of the plain sheet is performed as described below.

That is, the control unit 80 first transfers an image of a preceding page from the images of both surfaces to be formed to this plain sheet, to the sheet that is supplied from the first sheet supply device 40A or the second sheet supply device 40B, and reaches the secondary transfer section via the first transporting path R1, using the secondary transfer device 30. Then, the image of the preceding page transferred is fixed on this plain sheet by the fixing device 50.

Thereafter, the control unit 80 reverses the front and back of the plain sheet using the first reversal device 100, and transports the plain sheet along the fourth transporting path R4 and the first transporting path R1, using the plural feed rolls 48 provided at the fourth transporting path R4 and the first transporting path R1. Thereafter, an image of the following page from the images of both surfaces to be formed on this plain sheet is transferred by the secondary transfer device 30. Then, the image of the following page transferred is fixed on this plain sheet by the fixing device 50.

Then, the control unit 80 transports the plain sheet that has the images formed on both surfaces thereof to the downstream side and discharges the plain sheet from the opening portion 3, without reversing the front and back of the plain sheet using the second reversal device 110. Since the plain sheet is discharged without being reversed by the second reversal device 110, the plain sheet is dropped onto the sheet stack section 4, in a state where the surface on which the image of the following page is formed is turned up, and is stacked in this state.

The processing of the control unit 80 described above will be described using a flowchart.

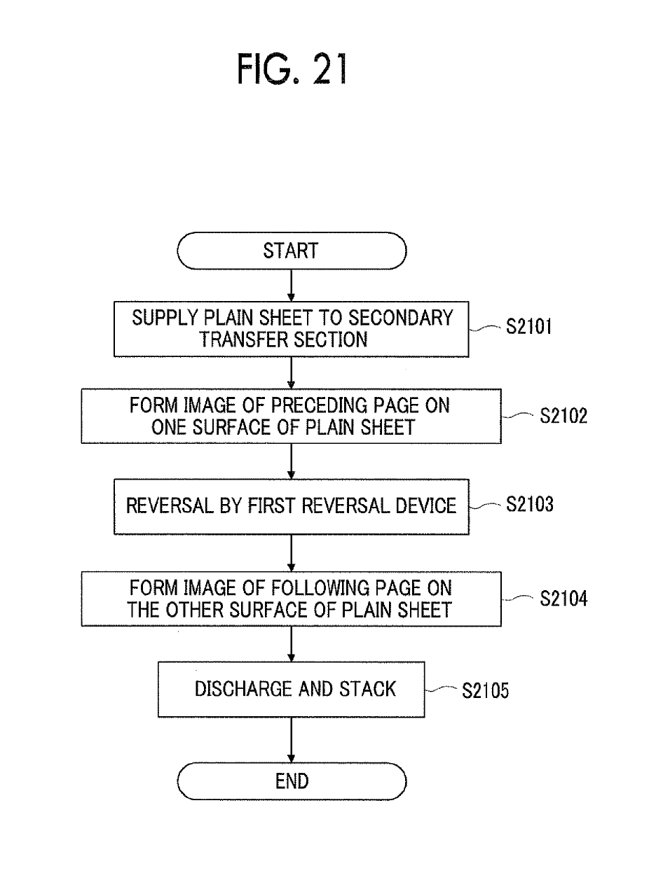

FIG. 21 is a flowchart showing a procedure when the control unit 80 performs image formation on both surfaces of a plain sheet within a bundle of sheets including a tabbed sheet.

The control unit 80 supplies the plain sheet to the secondary transfer section (S2101), and forms an image of a preceding page on one surface of the plain sheet using the secondary transfer device 30 and the fixing device 50 (S2102). Thereafter, the front and back of the plain sheet that has the image of the preceding page formed on one surface thereof are reversed by the first reversal device 100 (S2103). Thereafter, the plain sheet is supplied to the secondary transfer section, and an image of a following page is formed on the other surface of the plain sheet (S2104). Thereafter, the plain sheet that has the images formed on both surfaces thereof is discharged from the opening portion 3, and is stacked on the sheet stack section 4 (S2105).

Even in this other operation example, as the control unit 80 performs image formation on tabbed sheet and plain sheet within a bundle of sheets including the tabbed sheet, both the tabbed sheet and the plain sheet are stacked on the sheet stack section 4, in a state where a surface, on which an image of the following page from the images of both surfaces to be formed on the tabbed sheet or the plain sheet is formed, is turned up. Thus, the plain sheet and the tabbed sheet are stacked in an orderly manner in a state where the sheet numbers of the bundle of sheets are put in order.

In the image forming apparatus 1 related to the above-described exemplary embodiment, the second reversal device 110 is provided in the housing 2 of the image forming apparatus 1. However, the invention is not limited to this aspect. A device that reverses the front and back of sheet such that the leading edge and trailing edge of the sheet in the sheet transporting direction are switched may be connected to the outside of the image forming apparatus 1.

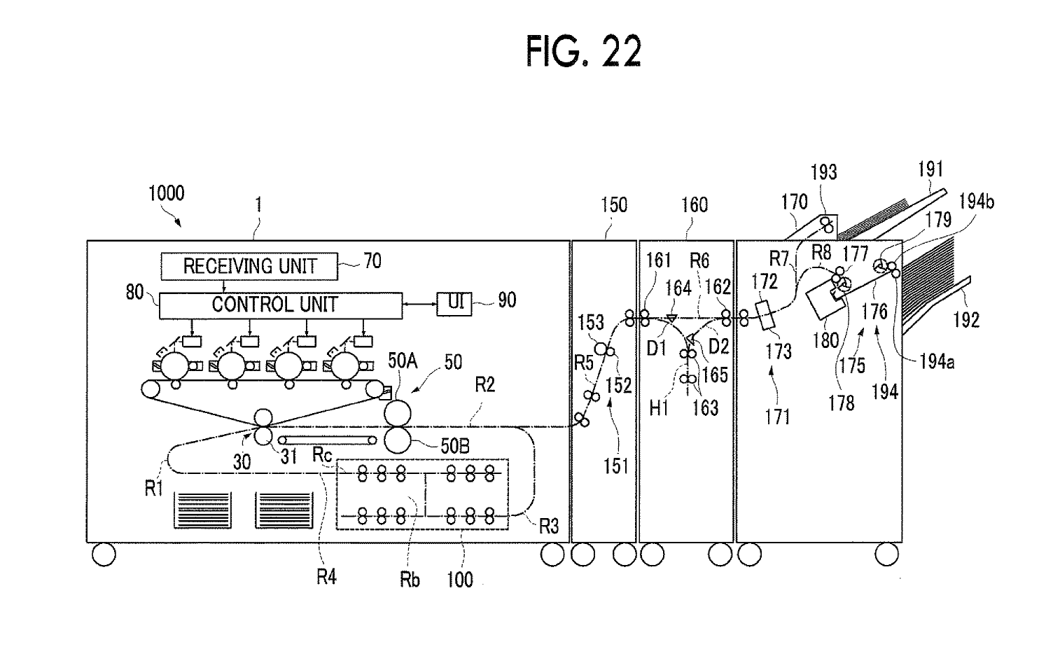

FIG. 22 is a view showing the schematic configuration of the sheet processing system 1000.

A sheet processing system 1000 as an example of an image forming system includes the above-described image forming apparatus 1 (here, excluding the sheet stack section 4), a first post-processing device 150 that has a curling-correcting processing unit 151 that corrects curling of sheet, a second reversal device 160 as an example of a leading edge reversal unit that reverses the front and back of sheet such that the leading edge and trailing edge of the sheet in the sheet transporting direction are switched, and a second post-processing device 170 including, for example, staples for end binding or a compile tray that collects and bundles sheet. In the sheet processing system 1000 shown in FIG. 22, the first post-processing device 150 is connected to the image forming apparatus 1, the second reversal device 160 is connected to the first post-processing device 150, and the second post-processing device 170 is connected to the second reversal device 160. The operation of respective sections of the first post-processing devices 150, the second reversal device 160, and the second post-processing device 170 is controlled by the control unit 80 of the image forming apparatus 1.

In addition, in this case, the image forming apparatus 1 may not be provided with the lead-out path D2 and the second gate 113 that are provided at the above-described image forming apparatus 1, and the feed roll 48 may be used instead of the feed rolls 111 for reversal.

The curling-correcting processing unit 151 of the first post-processing device 150 has a roll 152 arranged on the way of the sheet transporting path R5, and a sponge roll 153 that is different in thickness from the roll 152, and the sponge roll 153 is configured so as to be pressed (nipped) to such a degree that the sponge roll 153 bites into the roll 152. Curling is corrected by passing the sheet curled due to heating and pressurization during fusion or fixing of toner through a nip between the sponge roll 153 and the roll 152 and forcibly drawing the sheet in a direction opposite to the curling direction.

The second reversal device 160 is formed with a horizontal transporting path R6 along which a sheet P passes through the inside of the second reversal device 160 in the horizontal direction, the reversal path H1 that extends in the direction that intersects the horizontal transporting path R6, an introduction path D1 along which a sheet P is introduced from the horizontal transporting path R6 to the reversal path H1, and a lead-out path D2 along which a sheet P is led out from the reversal path H1 to the horizontal transporting path R6. The second reversal device 160 includes, on the horizontal transporting path R6, an inlet-side roll 161 that receives the sheet P discharged from the first post-processing device 150 into the apparatus housing, and an outlet-side roll 162 that discharges the sheet P received in the apparatus housing to the outside of the apparatus housing. Additionally, the second reversal device 160 includes plural rotatable (two in this example) feed rolls 163 for reversal in both directions on the reversal path H1. The feed rolls 163 for reversal rotate in one rotational direction when sheet is introduced from the horizontal transporting path R6 to the reversal path H1 via the introduction path D1 so as to reverse the sheet P, and rotates in the other rotational direction when a sheet P is led out from the reversal path H1 to the horizontal transporting path R6 via the lead-out path D2.

The second reversal device 160 includes a first gate 164 that switches whether the sheet P transported by the inlet-side roll 161 is passed through the horizontal transporting path R6 or whether the sheet is guided to the reversal path H1 via the introduction path D1, at a connection portion of the introduction path D1 to the horizontal transporting path R6. Additionally, the second reversal device 160 includes a second gate 165 that switches whether the sheet P passed through the introduction path D1 is guided to the reversal path H1 or whether the sheet is guided from the reversal path H1 via the lead-out path D2 to the horizontal transporting path R6, at a connection portion between the introduction path D1 and the lead-out path D2.

In the second reversal device 160 configured in this way, the control unit 80 controls the driving of the inlet-side roll 161, the outlet-side roll 162, and the feed rolls 163 for reversal, and the positions of the first gate 164 and the second gate 165, to control the simple passage of a sheet P through the second reversal device 160 or control the reversing of the front and back of the sheet P such that the leading edge and trailing edge of the sheet in the sheet transporting direction are switched.

The second post-processing device 170 includes a punching processing unit 171 that performs punching processing on sheet, and an alignment processing unit 175 carries out the processing of aligning sheet, and a binding processing unit 180 that performs binding processing on a bundle of sheets. Additionally, the second post-processing device 170 includes a first stack tray 191 for sheet stacking arranged at an upper portion, a second stack tray 192 for sheet stacking attached to a side edge of the apparatus housing, a first ejection roll 193 that discharges a sheet P toward the first stack tray 191, and a second ejection roll 194 that discharges a sheet P toward the second stack tray 192. The second post-processing device 170 is formed with a main sheet transporting path R7 that is connected to the horizontal transporting path R6 of the second reversal device 160, and guides a sheet P to the first stack tray 191, a branch transporting path R8 that branches from the main sheet transporting path R7, and guides a sheet P to the alignment processing unit 175.

The punching processing unit 171 has a punch 172 that performs punching as plural (for example, two and four) punching pins protrude and retract with respect to sheet surfaces, and a collection box 173 that collects sheet scraps that come out during punching, on the way of the main sheet transporting path R7. The punching processing using this punching processing unit 40 is performed as the sheet P guided along the main sheet transporting path R7 is stopped at a position that faces the punch 172, and the punch 172 passes the punching pins through the sheet P in the stopped state.

The alignment processing unit 175 includes a compile tray 176 that collects and accommodates plural sheets of papers P, and an exit roll 177 that is a pair of rolls that discharge a sheet P toward the compile tray 176. Additionally, the alignment processing unit includes a main paddle 178 and a sub-paddle 179 that rotate in order to push in the trailing edge of a sheet P toward an end guide of the compile tray 176, and a tamper (not shown) for performing alignment of both ends of the sheet in a direction orthogonal to the sheet transporting direction of the compile tray 176. The alignment processing using the alignment processing unit 175 is performed by sending out and stacking the sheet P transported from the branch transporting path R8 such that every sheet of sheet is discharged onto the compile tray 176 by the exit roll 177 and carrying out a feeding operation using the paddles 178 and 179 and a both end alignment operation using the tamper, on every sheet of sheet stacked on the compile tray 176.

The second ejection roll 194 has a first roll 194a provided so as to be fixed to a tray end of the compile tray 176, and a second roll 194b that comes into contact with the first roll 194a to form a nip, and withdraws upward to release the nip.

The binding processing unit 180 includes a stapler (not shown) that is provided at a lower end of the compile tray 176, and performs binding processing on a bundle of sheets stacked on the compile tray 176, and a sliding moving mechanism (not shown) that moves this stapler according to the binding-processed portion. Then, the binding processing using the binding processing unit 180 is performed as the stapler moves and stops a bundle of sheets on the compile tray 176 subjected to alignment processing, up to a binding position via the sliding moving mechanism, and executes a binding operation (placing of a staple). In this case, the bundle of sheets on the compile tray 176 is held in a pinched state at the nip of the second ejection roll 194.

In the second post-processing device 170, a sheet P may be directly discharged, stacked, and accommodated to the second stack tray 192 without carrying out the above alignment processing and binding processing. In this case, the second ejection roll 194 is brought into a nip forming state. Thereby, the sheet sent out by the exit roll 177 from the branch transporting path R8 is sent out until the leading edge of the sheet in the feeding direction reaches the nip of the second ejection roll 194 in a state where the sheet is brought into contact with the stacking side of the compile tray 176, is held by the nip in the stage where the sheet has reached the second ejection roll 194, and is transported and discharged to the second stack tray 192.

Additionally, a bundle of sheets that is subjected to only alignment processing without performing binding processing may be discharged, stacked, and accommodated to the second stack tray 192 as it is. Even in this case, after alignment processing of plural sheets of sheet on the compile tray 176 is performed, the second roll 194b of the second ejection roll 194 goes down, and is brought into the state of pinching a bundle of sheets between the first roll 194a and the second roll, and the bundle of sheets is carried out and stacked onto the second stack tray 192 by the second ejection roll 194 in that state.

In the sheet processing system 1000 configured as described above, when image formation is performed on both surfaces of each sheet of sheet within a bundle of sheets including a tabbed sheet, the control unit 80 may reverse the front and back of the sheet using the second reversal device 160 instead of reversing the front and back of the sheet using the second reversal device 110 in the image forming apparatus 1.

That is, in the example described with reference to FIG. 17, when image formation is performed on a bundle of sheets including a tabbed sheet, a sheet may be discharged from the opening portion 3 after image formation is performed on both surfaces of the sheet by the image forming apparatus 1 irrespective of tabbed sheet or plain sheet. Thereafter, the front and back of the sheet may be reversed by the second reversal device 160, and the sheet may then be stacked on the first stack tray 191 or the second stack tray 192.

In the example described with reference to FIG. 20, in the case of the tabbed sheet, the sheet may be discharged from the opening portion 3 after image formation is performed on both surfaces of the sheet by the image forming apparatus 1. Thereafter, the front and back of the sheet may be reversed by the second reversal device 160, and the sheet may then be stacked on the first stack tray 191 or the second stack tray 192. In the case of the plain sheet, the sheet may be discharged from the opening portion 3 after image formation is performed on both surfaces of the sheet by the image forming apparatus 1. Thereafter, the sheet may be stacked on the first stack tray 191 or the second stack tray 192 without reversing the front and back of the sheet using the second reversal device 160.

Thereby, both the tabbed sheet and the plain sheet are stacked on the first stack tray 191 or the second stack tray 192 in a state where a surface, on which an image of a following page from the images of both surfaces to be formed on the tabbed sheet or the plain sheet is formed, is turned up. Thus, the plain sheet and the tabbed sheet are stacked in an orderly manner in a state where the sheet numbers of the bundle of sheets are put in order.

In addition, as well as providing, through a communication unit, a program that makes the image forming apparatus 1 or the sheet processing system 1000 realize a function of forming an image of a following page on tabbed sheet that is fed with an edge having a tab as a rear edge by the first feed roll 44, using the secondary transfer device 30, a function of reversing the front and back of the tabbed sheet on which the image of the following page is formed, using the first reversal device 100 in a state where the tab becomes the rear edge, a function of forming an image of a preceding page on the tabbed sheet the front and back of which are reversed by the first reversal device 100, using the secondary transfer device 30, and a function of transporting the tabbed sheet on which the image of the preceding page is formed to the downstream side after the front and back of the sheet are reversed by the second reversal device 110 (160), when there a request for image formation on the bundle of sheets including a tabbed sheet having a tab that is not straight for at least a portion of an edge and there is a request for image formation on both surfaces of the tabbed sheet, it is also possible to store the program in recording media, such as CDROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image forming unit that forms an image on a sheet having a first edge, a second edge located opposite to the first edge, a first side edge intersecting the first edge, and a second side edge located opposite to the first side edge;
a feeding unit that feeds the sheet to the image forming unit from the first edge;
a transporting unit that transports the sheet;
a side edge reversal unit having a carrying-in section that carries in the sheet from the first edge, a reversal section that reverses the front and back of the sheet carried in by the carrying-in section, and a carrying-out section that carries out the sheet from the first edge after the sheet is reversed by the reversal section;
a leading edge reversal unit that reverses the front and back of the sheet transported with the first edge as a leading edge and changes the leading edge from the first edge to the second edge; and
a control unit that controls the operation of the image forming unit, the feeding unit, the transporting unit, the side edge reversal unit, and the leading edge reversal unit,
wherein, when there is a request for image formation on a bundle of sheets including a special sheet having a special part at an edge so that the edge is not straight and
there is a request for image formation on both surfaces of the special sheet,
the control unit controls
the feeding unit to feed the special sheet with the edge having the special part as a trailing edge,
the image forming unit to form an image of a following page on the special sheet,
the side edge reversal unit to reverse the front and back of the special sheet having the image of the following page formed thereon, in a state where the special part is positioned at a trailing edge,
the image forming unit to form an image of a preceding page on the special sheet of which the front and back are reversed by the side edge reversal unit, and
the transporting unit to transport the special sheet having the image of the preceding page formed thereon to the downstream side after the front and back of the sheet are reversed by the leading edge reversal unit.

2. The image forming system according to claim 1,
wherein, when the sheet having no special part and the special sheet are included in the bundle of sheets and there is a request for image formation on both surfaces of the sheet,
the control unit controls
the image forming unit to form an image of a preceding page on the sheet,
the side edge reversal unit to reverse the front and back of the sheet having the image of the preceding page formed thereon,
the image forming unit to form an image of a following page on the sheet of which the front and back are reversed by the side edge reversal unit, and
the transporting unit to transport the sheet having the image of the following page formed thereon to the downstream side, without reversing the front and back by the leading edge reversal unit.

3. The image forming system according to claim 1,
wherein, when the sheet having no special part and the special sheet are included in the bundle of sheets and there is a request for image formation on both surfaces of the sheet,
the control unit controls the image forming unit to form an image of a following page on the sheet,
the side edge reversal unit to reverse the front and back of the sheet having the image of the following page formed thereon,
the image forming unit to form an image of a preceding page on the sheet of which the front and back are reversed by the side edge reversal unit, and
the transporting unit to transport the sheet having the image of the preceding page formed thereon to the downstream side after the front and back are reversed by the leading edge reversal unit.

4. The image forming system according to claim 1, further comprising:
a detecting unit that detects the leading edge of the sheet on the upstream side of an image formation part of the image forming unit,
wherein the feeding unit feeds the sheet to the image formation part based on the detected result of the detecting unit.

5. The image forming system according to claim 2, further comprising:
a detecting unit that detects the leading edge of the sheet on the upstream side of an image formation part of the image forming unit,
wherein the feeding unit feeds the sheet to the image formation part based on the detected result of the detecting unit.

6. The image forming system according to claim 3, further comprising:
a detecting unit that detects the leading edge of the sheet on the upstream side of an image formation part of the image forming unit,
wherein the feeding unit feeds the sheet to the image formation part based on the detected result of the detecting unit.

7. An image forming method comprising:
when there is a request for image formation on a bundle of sheets including a special sheet having a special part at an edge of the special sheet so that the edge is not straight and there is a request for image formation on both surfaces of the special sheet,
forming an image of a following page on the special sheet fed with the edge having the special part as a trailing edge by a feeding unit, using an image forming unit,
reversing front and back of the special sheet having the image of the following page formed thereon, in a state where the special part is positioned at the trailing edge, using a side edge reversal unit,
forming an image of a first page on the special sheet of which the front and back are reversed by the side edge reversal unit, using an image forming unit, and
transporting the special sheet having the image of the preceding page formed thereon to the downstream side after the front and back of the sheet are reversed in a state where the special part is positioned at the leading edge by a leading edge reversal unit.

8. A non-transitory computer readable medium storing a program causing a computer to execute a processing for image forming,
the process comprising:
when there is a request for image formation on a bundle of sheets including a special sheet having a special part at an edge of the special sheet so that the edge is not straight and there is a request for image formation on both surfaces of the special sheet,
forming an image of a following page on the special sheet fed with the edge having the special part as a trailing edge by a feeding unit, using an image forming unit,
reversing the front and back of the special sheet having the image of the following page formed thereon, in a state where the special part is positioned at the trailing edge, using a side edge reversal unit,
forming an image of a preceding page on the special sheet of which the front and back are reversed by the side edge reversal unit, using an image forming unit, and
transporting the special sheet having the image of the preceding page formed thereon to the downstream side after the front and back of the sheet are reversed in a state where the special part is positioned at a leading edge by a leading edge reversal unit.
